(19) United States
(12) Patent Application Publication
(10) Pub. No.: US 2004/0185937 A1
(43) Pub. Date: Sep. 23, 2004

(54) Wireless communication terminal unit, gaming machine, information managing apparatus and gaming system

(75) Inventor: Kengo Takeda, Tokyo (JP)

Correspondence Address: Ronald R. Snider, P.O. Box 27613, Washington, DC, 20038-7613, US

(73) Assignee: Aruze Corporation, Tokyo (JP)

(21) Appl. No.: 10/790,097

(22) Filed: Mar. 2, 2004

(30) Foreign Application Priority Data
Mar. 4, 2003 (JP) 2003-057550
Mar. 10, 2003 (JP) 2003-063831

(51) Int. Cl. A63F 13/00

(52) U.S. Cl. 463/42

(57) ABSTRACT

Each wireless communication terminal unit is detachably attached to a gaming machine (1A-1H, 2A-2H). The transmitting/receiving device transmits/receives a predetermined information signal to/from a terminal, a gaming machine (1A-1H, 2A-2H), a mobile terminal (5A, 5B), or an information managing apparatus (4) in response to an information signal received from the mobile terminal (5A, 5B), by way of a receiving section which wirelessly receives information from the mobile terminal (5A, 5B).

### RELATED APPLICATIONS

This application claims the priorities of Japanese Patent Application No. 2003-057550 filed on Mar. 4, 2003 and Japanese Patent Application No. 2003-063831 filed on Mar. 10, 2003, which are incorporated herein by reference.

### BACKGROUND OF THE INVENTION

1. Field of the Invention

The present invention relates to a wireless communication terminal unit and a gaming machine. The present invention also relates to an information managing apparatus enabling communications between a gaming system employed in an arcade such as pachinko parlor and an arcade-related device such as money changer, card issuing machine, and intermediate device, for example; and a gaming system.

2. Description of the Prior Art

With the pervasion of the Internet, cellular phones, and the like, it has recently become possible for individuals to acquire necessary information easily, for example, by accessing various sites via the Internet while using cellular phones and the like. A person who wants to use an arcade such as amusement facility and pachinko parlor, for example, can acquire various kinds of information such as its location and business hours by accessing a site of the arcade.

A system has been known which allows various kinds of service such as renting of gaming balls, coins, and the like in an arcade such as pachinko parlor and exchanging of gifts in affiliated stores of the arcade (see, for example, Japanese Unexamined Patent Publication No. 2002-159730).

Also, systems have been proposed which provide information specific to individuals through a card such as a card affiliated with a credit company, an original member's card of the arcade, and a gift card usable in chain stores (see, for example, Japanese Unexamined Patent Publication Nos. HEI 10-328388, 5-115605, and 10-146442.

Though information such as an amusement facility and pachinko parlor can be collected via the Internet before going to an arcade, the information concerning gaming machines in the arcade or the like has not often been acquired directly by using a mobile terminal or the like in the arcade.

Usually, an individual collects information only sporadically, for example, by retrieving various sites via the Internet while using own cellular phone or the like so as to collect information items site by site. No system has been known which makes it possible to acquire information in various places such as amusement facilities, arcades, and restaurants and exchange information by using a mobile terminal.

The system providing information specific to individuals cannot operate without a dedicated card. Under the current circumstances where various kinds of cards exist, a user must choose and present an appropriate card from among a number of own cards. This complicates the management and utilization of cards, and necessitates a signup procedure each time the card is issued, whereby paperwork in various facilities becomes troublesome as well. Also, it takes time and cost to introduce such a system.

A gaming system has been disclosed in which a monitor computer connected to a gaming machine receives data such as design data and behavior data from the gaming machine, and transmits a predetermined signal to a device such as a transceiver owned by a floor staff member if it is determined according to the data that a false deed is done in the gaming machine, so as to inform the floor staff member of the false deed (see, for example, Japanese Unexamined Patent Publication No. HEI 10-201931). Thus, wireless data communications in the arcade make it easier to manage games, information, and the like in the arcade, thereby alleviating the workload of floor staff member and so forth.

However, the floor staff member of the arcade not only monitors false deeds as mentioned above, but also carries out various works to mend the shortage of changes in money changers, card issuing machines, and the like, and the clogging with balls, attaches a plate to the gaming machine at the time of a jackpot, and transports gaming media, for example. The floor staff member is busily running around the arcade for these works. When the shortage of changes or the like occurs in a money changer, a card issuing machine, and the like, players may feel a bad impression or sense of discomfort with respect to the arcade in particular. Therefore, the shortage of changes or the like must be mended rapidly, which is one of cumbersome works for the floor staff member. Unlike the clogging with balls occurring unexpectedly, the shortage of changes or the like can be prevented from occurring by seeing the amount of money in money changers, card issuing machines, and the like. In practice, however, it is difficult for the floor staff member busily running around the arcade to carry out such an operation.

The gaming systems disclosed in the above-mentioned two publications, Nos. 2002-159730 and HEI 10-201931, do not overcome such a problem. Hence, there has been a demand for providing a gaming system which can further improve the efficiency in work of the floor staff member.

### SUMMARY OF THE INVENTION

In view of the problems mentioned above, it is an object of the present invention to provide a wireless communication terminal unit which can easily be placed in various facilities at a relatively low cost, and with which a user can acquire desirable information and exchange information in various facilities, and a gaming machine equipped with the wireless communication terminal unit.

Also, in view of the above-mentioned problems, it is an object of the present invention to provide a gaming system and an information managing apparatus which can accurately provide in a timely manner a floor staff member of an arcade with information concerning an object to be reported in a device related to the arcade, such as money changer and card issuing machine.

The present invention provides a gaming system having transmitting/receiving means;

the transmitting/receiving means comprising a receiving section, connected via a communication line to a terminal or gaming machine placed in a facility, for wirelessly receiving information from a mobile terminal;

the transmitting/receiving means for transmitting/receiving a predetermined information signal to/from the terminal, the gaming machine, the mobile terminal, or an information managing apparatus placed in the facility in response to an information signal received from the mobile terminal by way of the receiving section; and

the transmitting/receiving means is provided with the terminal, the gaming machine, or the information managing apparatus placed in the facility.

The present invention provides a wireless communication terminal unit having a transmitting/receiving means;

the transmitting/receiving means comprising a receiving section, connected via a communication line to a terminal or gaming machine placed in a facility, for wirelessly receiving information from a mobile terminal; and

the transmitting/receiving means for transmitting/receiving a predetermined information signal to/from the terminal, the gaming machine, the mobile terminal, or an information managing apparatus placed in the facility in response to an information signal received from the mobile terminal by way of the receiving section.

The wireless communication terminal unit may further comprise a connecting part which connects with a monitor camera module which monitors the facility.

The wireless communication terminal unit may have a structure attachable to and detachable from the terminal or gaming machine.

In the wireless communication terminal unit, the receiving section may comprise a receiving surface which receives a personal information signal transmitted from a position in front of the gaming machine.

The personal information signal may be transmitted via an infrared ray.

The wireless communication terminal unit may be connected to the terminal or the gaming machine via a wired or wireless communication line.

The wireless communication terminal unit may be connected to the information managing apparatus via a wired or wireless communication line.

The terminal placed in the facility may be a terminal which stores therein at least one of information concerning the gaming machine and information concerning a whole arcade where the gaming machine is placed.

The terminal placed in the facility may be a device which rents a gaming medium utilized in the gaming machine.

The terminal placed in the facility may be a device which exchanges money.

The facility where the terminal is placed may be an arcade, an amusement facility where the game machine is placed, a restaurant, or a convenience store.

The present invention provides a gaming machine having a transmitting/receiving means;

the transmitting/receiving means comprising a receiving section, connected via a communication line to a terminal or gaming machine placed in a facility, for wirelessly receiving information from a mobile terminal; and

the transmitting/receiving means for transmitting/receiving a predetermined information signal to/from the terminal, the gaming machine, the mobile terminal, or an information managing apparatus placed in the facility in response to an information signal received from the mobile terminal by way of the receiving section;

wherein the gaming machine further comprises attachment means for being attachable to and detachable from the wireless communication terminal unit.

The gaming machine may be a pachinko gaming machine or a slot machine.

The present invention provides a gaming system comprising a plurality of the gaming machines, at least one of the gaming machines being connected via a communication line to the information managing apparatus and having an attachment which is attachable to and detachable from the wireless communication terminal unit having a transmitting/receiving means;

the transmitting/receiving means comprising a receiving section, connected via a communication line to a terminal or gaming machine placed in a facility, for wirelessly receiving information from a mobile terminal; and

the transmitting/receiving means for transmitting/receiving a predetermined information signal to/from the terminal, the gaming machine, the mobile terminal, or an information managing apparatus placed in the facility in response to an information signal received from the mobile terminal by way of the receiving section.

The present invention provides a gaming system comprising the wireless communication terminal unit, and a mobile terminal which communicates with the wireless communication terminal unit, the mobile terminal being a cellular phone, a laptop computer, or a PDA (Personal Digital Assistant).

The present invention provides a gaming system comprising:

an arcade-related device which is placed in an arcade and provides a predetermined service in response to insertion of a coin;

an information managing apparatus which is connected to the arcade-related device via a communication line and which comprises transmitting/receiving means adapted to wirelessly communicate with a mobile terminal operated by a floor staff member of the arcade; and

notification signal transmitting means for transmitting a notification signal to the information managing apparatus when a value of an object to be reported in the arcade-related device reaches a predetermined reference value;

the transmitting/receiving means comprises:

signal receiving means for receiving the notification signal;

and alarm signal transmitting means for transmitting an alarm signal to the mobile terminal for displaying onto a display section of the mobile terminal an alarm image indicating that the value of the object to be reported in the arcade-related device sending the notification signal has reached the predetermined reference value when the notification signal is received.

The value of the object to be reported may be the amount of money stored in the arcade-related device.

The alarm image may include an image indicative of a position of the arcade-related device sending the notification signal.

The mobile terminal may be a cellular phone, a laptop computer, or a PDA (Personal Digital Assistant).

The arcade-related device and the information managing apparatus may be connected to each other via a wired or wireless communication line.

The wireless communication with the mobile terminal may be made via an infrared ray.

The arcade-related device may be a device which rents a gaming medium utilized in the gaming machine.

The arcade-related device may be a device which exchanges money.

The arcade-related device may be a prepaid card issuing machine.

Data for the alarm image may be stored in storage means of the information managing apparatus and transmitted to the mobile terminal together with the alarm signal.

Data for the alarm image may be stored in storage means of the mobile terminal and displayed onto the display section of the mobile terminal when the mobile terminal receives the alarm signal.

The arcade-related device may be a device which rents a gaming medium utilized in the gaming machine, whereas the gaming system may comprise at least one of a bill nearly-full sensor which outputs a predetermined detection signal when the amount of stored bills reaches a predetermined upper limit, and a gaming medium nearly-end sensor which outputs a predetermined detection signal when the amount of stored gaming media reaches a predetermined lower limit.

The arcade-related device may be a device which exchanges money, whereas the gaming system may comprise at least one of a bill nearly-end sensor which outputs a predetermined detection signal when the amount of stored bills reaches a predetermined lower limit, and a coin nearly-end sensor which outputs a predetermined detection signal when the amount of stored coins reaches a predetermined lower limit.

The arcade-related device may be a prepaid card issuing machine, whereas the gaming system may comprise a card nearly-end sensor which outputs a predetermined detection signal when the amount of stored prepaid cards reaches a predetermined lower limit.

The present invention provides an information managing apparatus having transmitting/receiving means;

the transmitting/receiving means comprising:

notification signal receiving means connected via a communication line to an arcade-related device placed in an arcade and adapted to provide a predetermined service in response to insertion of a coin, for enabling a wireless communication with a mobile terminal operated by a floor staff member of the arcade, and receiving a notification signal transmitted from the arcade-related device when a value of an object to be reported in the arcade-related device reaches a predetermined reference value; and

alarm signal transmitting means for transmitting an alarm signal to the mobile terminal so as to display onto a display section of the mobile terminal an alarm image indicating that the value of the object to be reported in the arcade-related device sending the notification signal when the notification signal is received.

The value of the object to be reported may be the amount of money stored in the arcade-related device.

### BRIEF DESCRIPTION OF THE DRAWINGS

FIG. 1 is a perspective view schematically showing an example of a pachinko gaming machine equipped with a wireless communication terminal unit;

FIG. 2 is a perspective view schematically showing another example of a pachinko gaming machine equipped with a wireless communication terminal unit;

FIG. 3 is a block diagram showing the configuration of the pachinko gaming machine shown in FIG. 1;

FIG. 4 is a block diagram showing an inner structure of a wireless communication terminal unit provided with the pachinko gaming machine shown in FIG. 1;

FIG. 5 is a diagram schematically showing an example of a gaming system equipped with the pachinko gaming machine shown in FIG. 1 and the like;

FIG. 6 is a block diagram schematically showing the inner configuration of an information managing apparatus shown in FIG. 5;

FIG. 7 is a flowchart showing a subroutine executed in the wireless communication terminal unit shown in FIG. 4;

FIGS. 8A to 8D are views schematically showing examples of images displayed on a display section of a cellular phone shown in FIG. 5;

FIGS. 9A to 9C are views schematically showing examples of images displayed on the display section of the cellular phone shown in FIG. 5;

FIG. 10 is a diagram schematically showing an example of the gaming system in accordance with the present invention;

FIG. 11 is a perspective view schematically showing an intermediate device 1004 shown in FIG. 10;

FIG. 12 is a block diagram showing the inner configuration of the intermediate device 1004 shown in FIG. 10;

FIG. 13 is a flowchart showing a subroutine executed in the intermediate device 1004 shown in FIG. 10;

FIG. 14 is a perspective view schematically showing a money changer 1005 shown in FIG. 10;

FIG. 15 is a block diagram showing the inner configuration of the money changer 1005 shown in FIG. 10;

FIG. 16 is a flowchart showing a subroutine executed in the money changer 1005 shown in FIG. 10;

FIG. 17 is a perspective view schematically showing a card issuing machine 1006 shown in FIG. 10;

FIG. 18 is a block diagram showing the inner configuration of the card issuing machine 1006 shown in FIG. 10;

FIG. 19 is a flowchart showing a subroutine executed in the card issuing machine 1006 shown in FIG. 10;

FIG. 20 is a block diagram showing the inner configuration of an information managing apparatus 1010 shown in FIG. 10;

FIG. 21 is a flowchart showing a subroutine executed in the information managing apparatus 1010 shown in FIG. 10; and

FIGS. 22A to 22D are views schematically showing examples of images displayed on a display section of a cellular phone 1007 shown in FIG. 10.

### DESCRIPTION OF THE PREFERRED EMBODIMENTS

In the following, embodiments of the present invention will be explained with reference to the drawings.

### First Embodiment

To begin with, a wireless communication terminal unit in accordance with a first embodiment of the present invention and a gaming machine (gaming system) using this unit will be explained with reference to the drawings.

The wireless communication terminal unit in accordance with this embodiment will be explained together with the gaming machine. While the gaming machine can exchange various kinds of information with mobile terminals via the wireless communication terminal unit, the following explanation will be set forth assuming that the gaming machine comprises personal information signal transmitting means and response signal transmitting means.

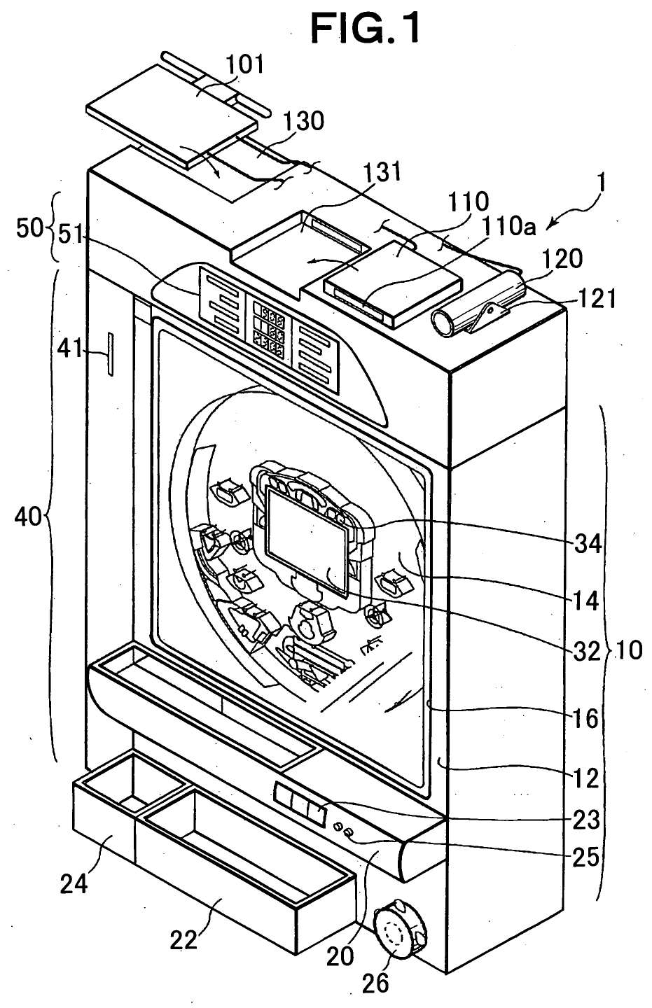

FIG. 1 is a perspective view schematically showing an example of pachinko gaming machine 1 equipped with a wireless communication terminal unit.

The pachinko gaming machine 1 comprises a main unit 10, an intermediate device 40 disposed on the right side of the main unit 10, a data display 50 placed on the upper side of the main unit 10, and a wireless communication terminal unit 100 detachably attached onto the upper side of the data display 50. Since the wireless communication terminal unit 100 is detachably attached to the gaming machine 1 as such, the unit 100 can easily be mounted and removed, and thus can easily conform to replacement of the gaming machine 1 and layout modifications in various facilities.

Namely, an upper part of a main frame 12 is provided with attachments 130, 131, whereas a main part 101 of the wireless communication terminal unit 100 is detachably attached to the attachment 130. A receiving section 110 is detachably attached to the attachment 131 such that a receiving surface 110a is directed forward, and can receive personal information signal transmitted from the front side of the pachinko gaming machine 1. A monitor camera 120 is connected to the main part 101 of the wireless communication terminal unit 100 by way of wiring, and is attached to an attachment 121.

The main unit 10 is provided with the main frame 12, a gaming board 14 built in the main frame 12, a window frame 16 of the main frame 12 attached to the front face of the gaming board 14, an upper tray 20 and a lower tray 22 which are disposed in front of the main frame 12 under the window frame 16, a shooting handle 26 disposed on the right side of the lower tray 22, and a cellular phone table 24 disposed on the left side of the lower tray 22. Placed on the front face of upper tray 20 are a number display 23 indicating points required for renting gaming balls, and operation buttons 25 by which instructions for renting gaming balls can be inputted.

A display device 32 for displaying a plurality of variable patterns, represented images, and the like is placed on the front face of the gaming board 14, whereas a plurality of obstructive nails (not depicted) are hammered therein.

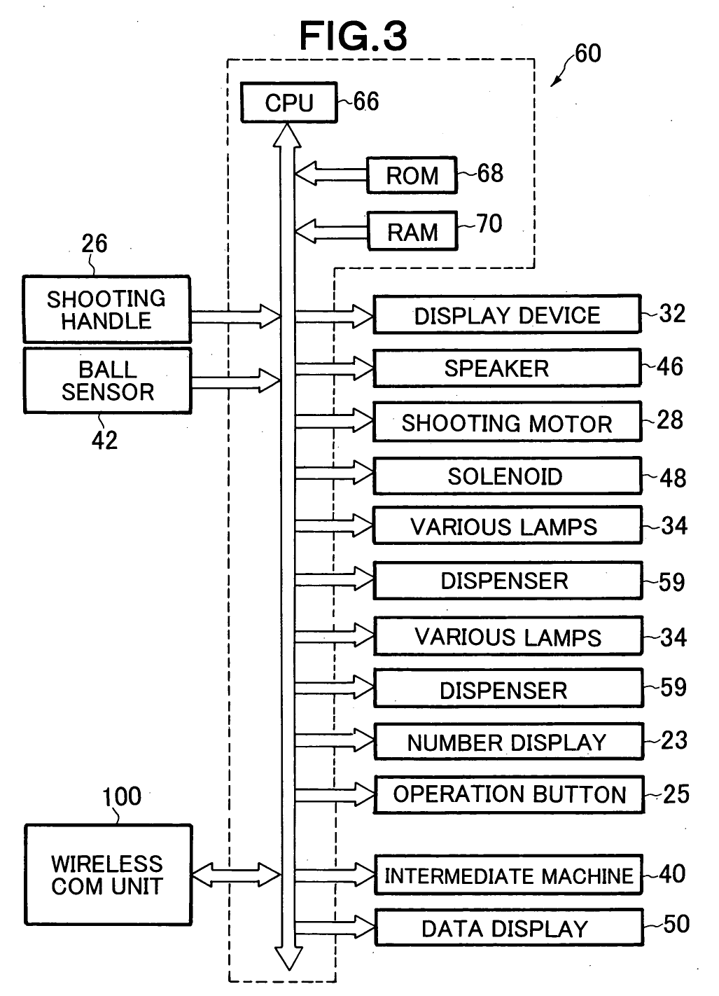

The shooting handle 26 is disposed so as to be rotatable with respect to the main frame 12, whereby a player can play a pachinko game by operating the shooting handle 26. Disposed on the rear side of the shooting handle 26 is a shooting motor 28 (see FIG. 3). When the shooting handle 26 is rotated by the player, power is supplied to the shooting motor 28, whereby gaming balls stored in the upper tray 20 are successively shot onto the gaming board 14. Thus shot gaming balls move to the upper side of the gaming board 14, and drop toward the lower side of the gaming board 14 while changing their advancing direction upon collisions with a plurality of obstructive nails.

The intermediate device 40 has a card insertion slot 41 formed in the front face thereof. When a prepaid card or the like is inserted into the card insertion slot 41, the point stored in the prepaid card is displayed on the number display 23. The data display 50 has a data display section 51 in the front face thereof, in which data based on gaming results in the pachinko gaming machine 1 and the like are displayed. As the intermediate device 40 and data display 50, those conventionally known can be employed.

The wireless communication terminal unit 100 comprises the main part 101 and the receiving section 110. The receiving section 110 has the receiving surface 110a, and thus can receive via the receiving surface 110a a personal information signal transmitted through infrared rays from a mobile terminal (not depicted). The receiving section 110 is disposed such that the receiving surface 110a is directed forward, and thus can receive the personal information signal transmitted from the front side of the pachinko gaming machine 1.

The receiving section 110 and the main part 101 are connected to each other by wiring, whereby the personal information received by the receiving section 110 is supplied to the main part 101. The monitor camera 120 is connected to the main part 101 of the wireless communication terminal unit 100, so that the arcade can be observed. Hence, the monitor camera 120 can also function as a security camera and the like. The wireless communication terminal unit 100 is connected to the pachinko gaming machine 1 via a communication line.

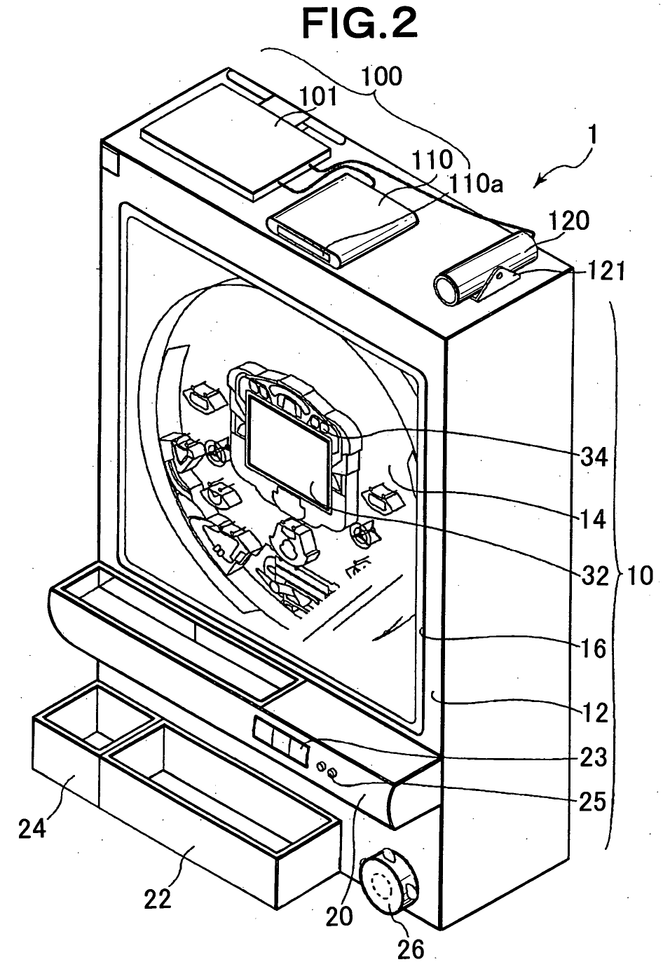

FIG. 2 is a perspective view showing another example of the pachinko gaming machine equipped with the wireless communication terminal unit 100. In FIG. 2, constituents corresponding to those shown in FIG. 1 are referred to with numerals identical thereto.

While this pachinko gaming machine 7 comprises a main unit 10 and a wireless communication terminal unit 100, no recess (attachment) shown in FIG. 1 is formed in the upper part of the main frame 12, whereas the main part 101 and receiving section 110 of the wireless communication terminal unit 100 are attached thereto by a metal attachment which is not depicted.

The main unit 10 will not be explained here, since it is the same as that shown in FIG. 2 except for the points mentioned above.

It is not always necessary for the gaming machine of the present invention to comprise the intermediate device 40 and data display 50 as with the pachinko gaming machine 1 shown in FIG. 1 as long as it is equipped with the wireless communication terminal unit 100. The receiving section may be separated from the main unit 10 as shown in FIG. 1 or integrated with the main unit 10 as shown in FIG. 2.

FIG. 3 is a block diagram showing the configuration of the pachinko gaming machine 1 shown in FIG. 1. The pachinko gaming machine 1 comprises a control unit 60 including a CPU (Central Processing Unit) 66, a ROM (Read Only Memory) 68, and a RAM (Random Access Memory) 70.

The ROM 68 stores a program which controls the flow of the whole game in the pachinko gaming machine and the like, various kinds of image data displayed on the display device 32, various kinds of sound data outputted from a speaker 46 which will be explained later, and the like. The RAM 70 stores not only values of flags and variants used in the program, but also, for example, new input data, results of calculations by the CPU 66, cumulative reach numbers indicative of gaming histories, cumulative variable numbers, and cumulative jackpot numbers.

The CPU 66 calls and executes a predetermined program, so as to perform arithmetic operations, and carries out transmission and other kinds of control while using various kinds of image data and sound data as electronic data according to results of the arithmetic operations.

The shooting handle 26 and a ball sensor 42 are connected to the control unit 60. When the shooting handle 26 is operated, an angular signal indicative of the rotating angle of the shooting handle 26 is supplied to the control unit 60. Upon detecting a gaming ball entering a winning pocket or starter pocket provided in the gaming board 14, the ball sensor 42 transmits a detection signal to the control unit 60.

The display device 32 for displaying a plurality of variable patterns, represented images, and the like, and the speaker 46 for outputting various sounds conforming to gaming states are connected to the control unit 60.

Also, the shooting motor 28, a solenoid 48, and various lamps 34 are connected to the control unit 60, and are supplied with driving signals and driving powers according to results of arithmetic operations in the CPU 66.

Further, dispensers 59, the number display 23, and the operation buttons 25 are connected to the control unit 60. The dispensers 59 operate according to driving signals from the CPU 66, and pay out a predetermined number of gaming balls to the upper tray 22. The number display 23 displays points necessary for renting gaming balls.

The operation buttons 25 allow instructions for renting gaming balls to be inputted. When the operation buttons 25 are operated, the dispensers 59 dispense a predetermined number of gaming balls to the upper tray 22, whereby the number displayed on the number display 23 decreases.

Furthermore, the wireless communication terminal unit 100, the intermediate device 40, and the data display 50 are connected to the control unit 60.

When a prepaid card is inserted into the card insertion slot 41 of the intermediate device 40, the point stored in the prepaid card is displayed onto the number display 23. When gaming balls are rented, the point stored in the prepaid card is rewritten.

Points necessary for renting the gaming balls may also be provided according to a request signal received by the wireless communication terminal unit 100 from a mobile terminal without using the intermediate device 40.

The data display 50 displays various kinds of data according to results of gaming in the pachinko gaming machine 1. These kinds of data are stored in the RAM 70.

Various kinds of data based on results of gaming may be displayed onto the data display 50 constantly during when the pachinko gaming machine 1 is in operation or according to a request signal received by the wireless communication terminal unit 100 from a mobile terminal.

The wireless communication terminal unit 100 will now be explained.

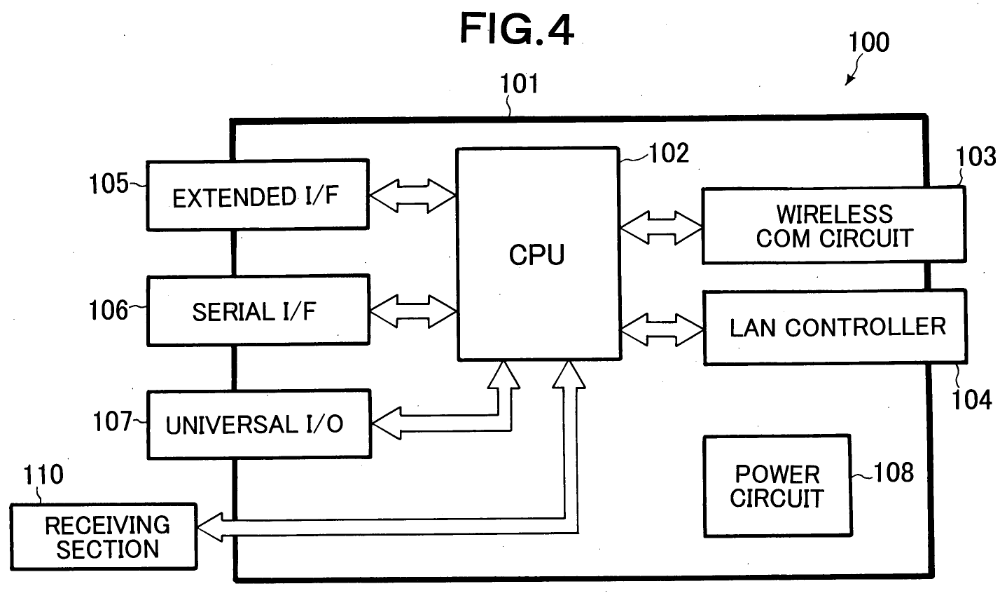

FIG. 4 is a block diagram showing the inner structure of the wireless communication terminal unit 100 provided with the pachinko gaming machine 1 shown in FIG. 1.

The wireless communication terminal unit 100 comprises the main part 101 and the receiving section 110. The main part 101 comprises a one-chip CPU 102 having a memory, whereas a wireless communication circuit 103, a LAN controller 104, an extended I/F 105, a serial I/F 106, and a universal I/O 107 are connected to the CPU 102. The main part 101 also comprises a power circuit 108.

The memory in the CPU 102 stores verification image data. When transmitting a response signal to a mobile terminal, the CPU 102 transmits the verification image data together therewith. As a result, a verification image based on the verification image data is displayed onto the display section of the mobile terminal.

The verification image data may also be stored in the ROM 68 provided with the pachinko gaming machine 1. In this case, the CPU 102 acquires the verification image data from the ROM 68 when transmitting a response signal to a mobile terminal, and transmits the response signal together with the verification image data.

The wireless communication circuit 103 makes it possible to transmit/receive data wirelessly to/from an information managing apparatus which is placed in an arcade and manages and controls other pachinko gaming machines, etc., other pachinko gaming machines 1, and/or slot machines and the like placed in the arcade. For example, a card type expansion device such as PC card can be employed for the wireless communication circuit 103. The LAN controller 104 makes it possible to transmit/receive data to/from the information managing apparatus, the pachinko gaming machines 1, and/or the slot machines by wire, for example.

For example, peripherals such as monitor camera and scanner can be connected to the extended I/F 105. The serial I/F 106 is an interface for carrying out serial transmissions, and can employ serial transmission schemes such as RS-232C and RS-422. The universal I/O 107 enables connections with other various kinds of devices/apparatus.

The pachinko gaming machine 1 shown in FIG. 1 is connected to the wireless communication terminal unit 100 by the serial I/F 106.

Usually, by the LAN controller 104 of the wireless communication terminal unit 100, the pachinko gaming machine 1 is connected via a wiring network to the information managing apparatus placed in the arcade. When a slot machine is placed in the arcade, the slot machine may also be connected via a wiring network to the information managing apparatus by the LAN controller 104 of the wireless communication terminal unit 100. A gaming system comprising the pachinko gaming machine 1 and the like will be explained later.

It is not always necessary for the wireless communication terminal unit 100 and the pachinko gaming machine 1 (slot machine) to be connected to each other by the serial I/F 106. They may be connected wirelessly by the wireless communication circuit or by wire with the LAN controller 104.

It is not always necessary for the wireless communication terminal unit 100 and the information managing apparatus to be connected by wire with the LAN controller 104. They may be connected wirelessly by the wireless communication circuit 104.

The receiving section 110 is connected to the CPU 102 of the main part 101. The receiving section 110 has the receiving surface 110a, by which personal information signals can be received from mobile terminals through infrared rays.

Though the gaming machine has been explained in terms of pachinko gaming machine so far, the gaming machine in the present invention encompasses not only pachinko gaming machines but also slot machines. In the latter case, the slot machines comprise the wireless communication terminal unit 100 as with the pachinko gaming machines.

The mobile terminal is not restricted in particular. Examples of the mobile terminal include cellular phones, laptop computers, and PDAs (Personal Digital Assistants).

The wireless communication terminal unit 100 can wirelessly receive information signals from mobile terminals, and can transmit/receive predetermined information signals to/from terminals, gaming machines, the mobile terminals, or the information managing apparatus placed in the arcade, and thus can construct a system for exchanging information with mobile terminals (cellular phones) owned by users and so forth in the arcade provided with pachinko gaming machines and the like.

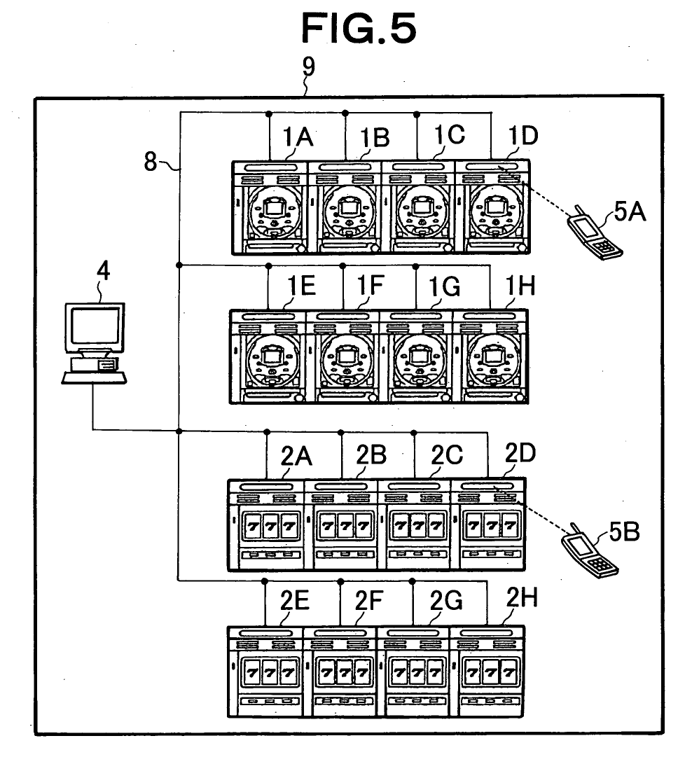

FIG. 5 is a diagram schematically showing an example of gaming system equipped with gaming machines in accordance with the present invention.

Eight pachinko gaming machines 1 (1A to 1H), eight slot machines 2 (2A to 2H), and an information managing apparatus 4 are placed in an arcade 9. The pachinko gaming machines 1 and slot machines 2 are connected via a wiring network 8 to the information managing apparatus 4. Each of the pachinko gaming machines 1 and slot machines 2 comprises the wireless communication terminal unit (not depicted) and can receive personal information signals from cellular phones 5 (5A to 5B) through infrared rays.

When each of the pachinko gaming machines 1 and slot machines 2 comprises personal information signal determining means and response signal transmitting means, the pachinko gaming machine 1 or slot machine 2 determines whether a personal information is received from a cellular phone 5 or not. When it is determined that the personal information signal is received, the pachinko gaming machine 1 or slot machine 2 transmits a response signal to the cellular phone 5 in order to cause the display section of the cellular phone 5 to display a verification image indicating that the personal information signal is received.

In the case where the information managing apparatus 4 comprises personal information signal determining means and response signal transmitting means, the pachinko gaming machine 1 or slot machine 2 transmits a personal information signal to the information managing apparatus 4 upon receiving this signal. The information managing apparatus 4 determines whether the personal information signal is received or not. When it is determined that the personal information signal is received, the information managing apparatus 4 transmits a response signal to the cellular phone 5 in order to cause the display section of the cellular phone 5 to display a verification image indicating that the personal information signal is received. Here, the information managing apparatus 4 may transmit a response signal to the cellular phone 5 directly or by way of the pachinko gaming machine 1 or slot machine 2.

In the gaming system, the information managing apparatus is a host computer in a broad sense. Namely, it encompasses not only host computers in a narrow sense (e.g., mainframe computers in vertically distributed systems), but also servers (e.g., workstations and personal computers in horizontally distributed systems). The information managing apparatus may be constituted by an assembly of a plurality of computers.

In the gaming system, the gaming machine comprises a receiving section for receiving personal information signals wirelessly from mobile terminals. The medium through which the personal information signals are transmitted from the mobile terminals to the gaming machine is not restricted in particular. For example, electric waves and infrared rays can be used.

In particular, infrared rays are preferably used as a communication medium for the personal information signals transmitted from the mobile terminals to the gaming machine. Namely, the gaming machine preferably comprises a receiving section for receiving personal information signals from the mobile terminals trough infrared rays. This is because infrared rays having an excellent directivity used as a communication medium can reduce erroneous emissions in which players transmit personal information signals to other gaming machines. Since communications can be carried out by directing a mobile terminal to a gaming machine, an input of an instruction for specifying a gaming machine to communicate can be omitted.

Communication specs for such infrared communications between mobile terminals and gaming machines are not restricted in particular. For example, IrDA (Infrared Data Association) can be used. The IrDA include a plurality of specs different from each other in terms of power consumption, communicable distance, and communication speed. Any spec can selectively be employed according to functions of mobile terminals and positions of receiving sections in gaming apparatus, for example, as appropriate without being restricted in particular.

In the gaming system, the gaming machines and the information managing apparatus are connected to each other via a communication line. The communication line encompasses not only wired lines, but also wireless transmission lines. Wired communication lines can improve security and realize high-speed communications. On the other hand, wireless communication lines can simplify the wiring operation for layout modifications of gaming machines and replacement of gaming machines. Communication schemes between the gaming machines and the information managing apparatus are not restricted in particular. When frequently replacing gaming machines, for example, the gaming machines and information managing apparatus may construct an ad-hoc network (autonomous distributed wireless network). Thus, a simple network can be constructed inexpensively.

In the gaming system, the gaming machine receives a personal information signal transmitted from a mobile terminal, for example. This personal information signal is a signal transmitted from the mobile terminal to the gaming machine together with or after transmitting a signal for requesting a specific operation (hereinafter referred to as request signal) when requesting the specific operation for the gaming machine, for example.

The specific operation required for the gaming machine is not restricted in particular. Examples of such an operation include operations concerning the renting gaming media (gaming balls, coins, and the like) and the providing of points necessary for renting these gaming media and operations concerning the displaying of data onto the data display according to gaming results. These operations will be explained later.

Personal information included in such a personal information signal from a mobile terminal to a gaming machine includes information concerning the mobile terminal and/or an individual owning the mobile terminal. Examples of the personal information included in the personal information signal transmitted from the mobile terminal include a phone number and a mail address. The personal information also includes a password arbitrarily set by the player and the like.

Specifically, when an IrDA spec is used for infrared communications between mobile terminals and gaming machines as mentioned above, a spec of IrMC (Infrared Mobile Communication), for example, is employed for transmitting/receiving personal information signals. In the IrMC spec, personal information is transmitted and received as personal information signals by vCard which is a common data format. In this case, the personal information is information corresponding to individual items of vCard.

In the gaming system, the mobile terminal receives a response signal from the gaming machine or information managing apparatus. The response signal may include image data (hereinafter referred to as verification image data) to become a verification image indicating that a personal information signal is received. When the response signal is received in this case, the verification image is displayed on the display section of the mobile terminal according to the verification image data included in the response signal. The verification image data may be stored beforehand in a memory of the mobile terminal, so that the verification image is displayed on the display section of the mobile terminal according to the verification image data when the mobile terminal receives the response signal.

When the gaming machine comprises response signal transmitting means, the response signal is wirelessly transmitted from the gaming machine to the mobile terminal. For the response signal, a communication medium similar to that of the personal information signal transmitted from the mobile terminal to the gaming machine can be used, examples of which include electric waves and infrared rays.

When the information managing apparatus comprises response signal transmitting means, on the other hand, the response signal is transmitted from the information managing apparatus to the mobile terminal by way of the gaming machine or directly transmitted in a wireless fashion from the information managing apparatus to the mobile terminal without the help of the gaming machine.

When the response signal is transmitted from the information managing apparatus to the mobile terminal by way of the gaming apparatus, the response signal is wirelessly transmitted from the gaming machine to the mobile terminal. For the response signal, a communication medium similar to that of the personal information signal transmitted from the mobile terminal to the gaming machine can be used, examples of which include electric waves and infrared rays. When the response signal is directly transmitted in a wireless fashion from the information managing apparatus to the mobile terminal without the help of the gaming machine, electric waves and the like can be used as a communication medium for the response signal.

The verification image displayed on the display section of the mobile terminal is not restricted in particular. Examples of the verification image include an image indicating that a request signal is received, and an image indicating that a password is inputted. If an additional instruction is inputted when proceeding with a specific operation related to the request signal, an image indicating that a request signal concerning the additional instruction is received may be displayed as a verification image on the display section of the mobile terminal. For example, a verification image may be displayed when a request signal related to the purchase of points is received, and a verification image may further be displayed when a request signal related to the amount of points to be purchased is received. The verification images will later be explained with reference to drawings.

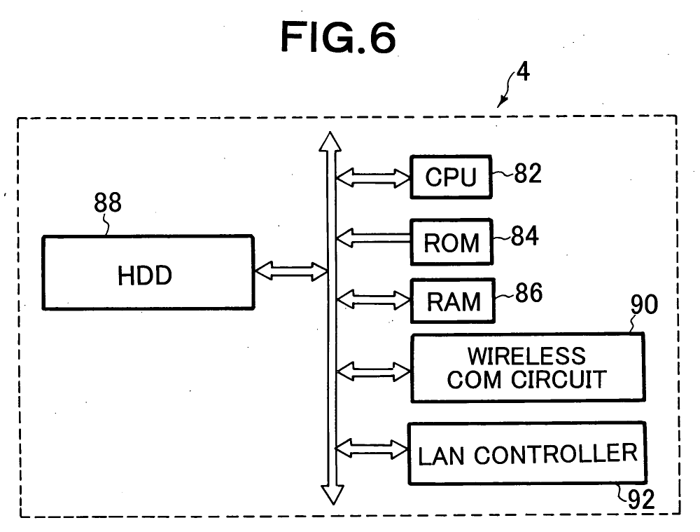

The information managing apparatus used in the gaming system will now be explained. FIG. 6 is a block diagram schematically showing the inner configuration of the information managing apparatus shown in FIG. 5.

The information managing apparatus 4 is constituted by a hard disk drive 88, a CPU 82, a ROM 84, a RAM 86, a wireless communication circuit 90, and a LAN controller 92.

The hard disk drive 88 stores, for example, a program for causing the wireless communication circuit 90 or LAN controller 92 to carry out communications with a pachinko gaming machine 1 or slot machine 2, a program for receiving personal information signals and the like from the wireless communication terminal unit 100 provided with the pachinko gaming machine 1 or slot machine 2, and a program for generating reception history data.

The wireless communication circuit 90 is used for wirelessly communicating with the wireless communication terminal unit 100, whereas the LAN controller 92 is used for communicating with the wireless communication terminal unit 100 by wire.

Though the information managing apparatus 4 is connected to the pachinko gaming machines 1 or slot machines 2 by wire via the wiring network 8 with the LAN controller 92 in the gaming system shown in FIG. 5, they may be connected wirelessly by the wireless communication circuit 90.

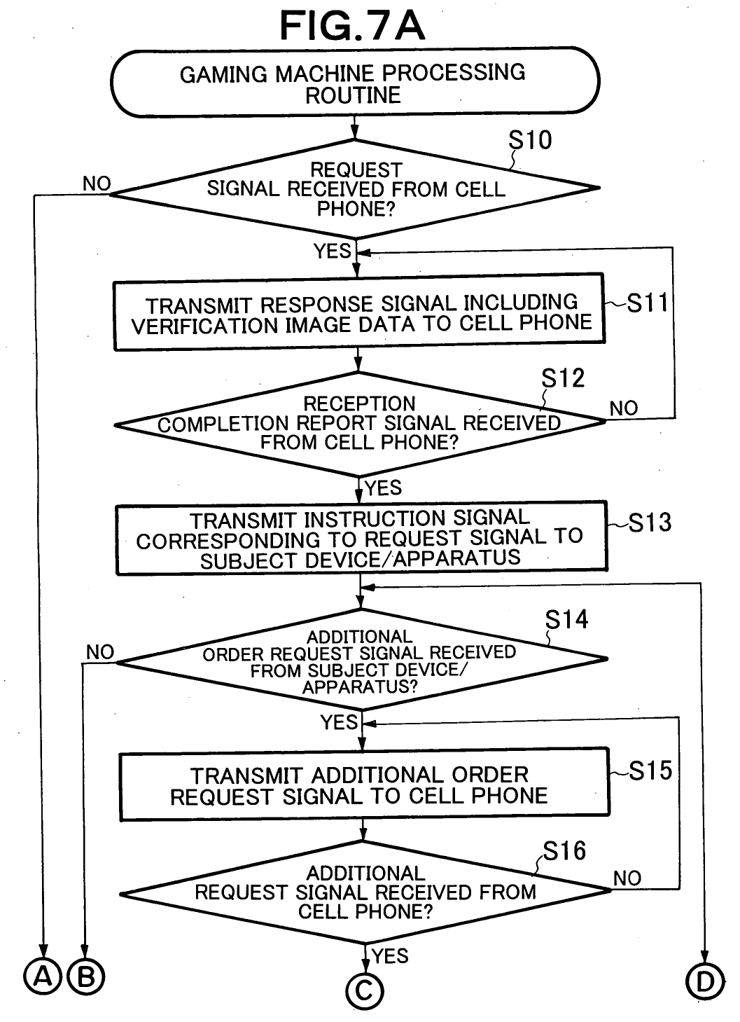

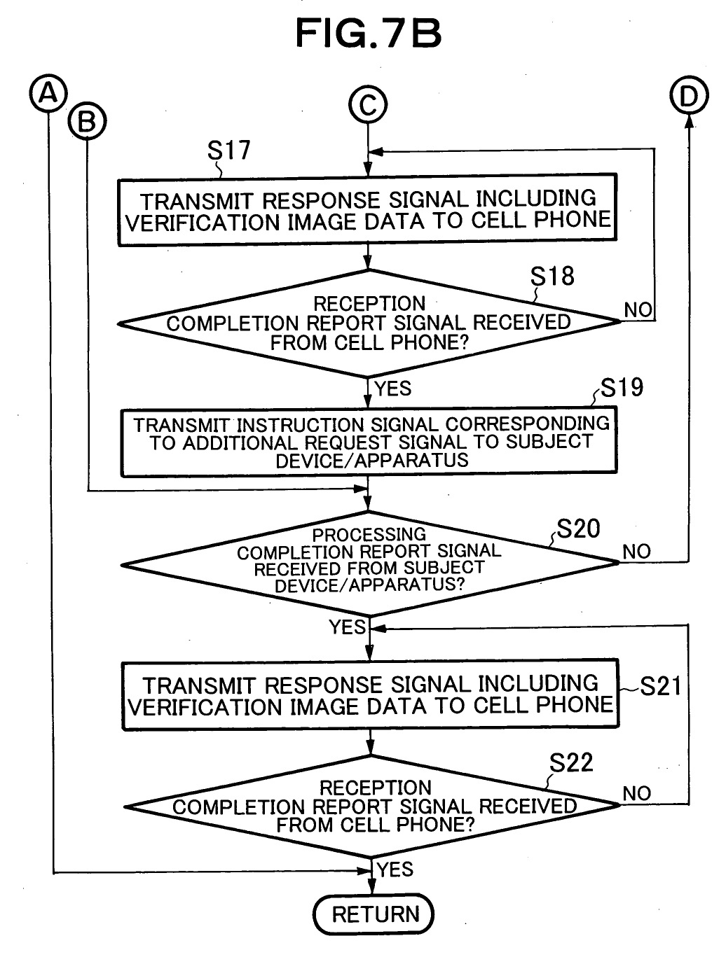

Processing operations performed in the gaming system will now be explained with reference to FIG. 7.

In the following, it is assumed that the pachinko gaming machine 1, wireless communication terminal unit 100, and information managing apparatus 4 are actuated, and variables used in the CPUs 66, 102, 82 are initialized to predetermined values, so that the CPUs operate in a steady state.

FIG. 7 is a flowchart showing a subroutine executed in the wireless communication terminal unit 100 provided with the pachinko gaming machine 1. This subroutine is executed while being called at a predetermined timing from a program executed beforehand for controlling operations of the wireless communication terminal unit 100 and the like.

First, the CPU 102 determines whether a request signal is received from the cellular phone 5 or not (step S10).

The request signal from the cellular phone 5 is not restricted in particular, examples of which include a signal requesting a process concerning the renting of gaming balls to be executed, a signal requesting a process concerning the providing of a point required for renting gaming balls to be executed, and a signal requesting a process related to the displaying of data onto the data display 50 according to gaming results to be executed.

If it is determined that the request signal from the cellular phone 5 is not received, the subroutine is terminated. If it is determined that the request signal from the cellular phone 5 is received, on the other hand, the CPU 102 transmits a response signal including verification image data to the cellular phone 5 (step S11).

When the verification image data is stored in a memory provided with the CPU 102 in the wireless communication terminal unit 100, the CPU 102 reads out necessary verification image data from the memory, and transmits the response signal to the cellular phone 5 together with the verification image data. When the verification image data is stored in the ROM 68 of the pachinko gaming machine 1, the CPU 102 acquires necessary verification image data from the ROM 68, and then transmits the response signal to the cellular phone 5 together with the verification image data.

The response signal can be transmitted from the wireless communication terminal unit 100 to the cellular phone 5 via infrared communications by way of the receiving section 110, for example. When the personal information related to the personal information signal includes a mail address, mail having the verification image data attached thereto may be transmitted as the response signal. When the verification image data is stored in a memory provided with the cellular phone 5, the response signal is transmitted alone without the verification image data.

When the processing of step S11 is carried out, and the cellular phone 5 receives the response signal, a verification image based on the verification image data is displayed on the display section of he cellular phone 5. When the cellular phone 5 receives the response signal, a signal indicating that the reception of the response signal is completed (hereinafter also referred to as reception completion report signal) is transmitted from the cellular phone 5.

Subsequently, the CPU 102 determines whether or not the reception completion report signal is received from the cellular phone 5 (step S12). When it is determined that the reception completion report signal is not received, the CPU 102 returns the processing to step S11, and transmits the response signal successively.

If it is determined in step S12 that the reception completion report signal is received, the CPU 102 transmits an instruction signal corresponding to the request signal to a subject device/apparatus (step S13).

When the request signal is a signal requesting the processing related to the renting of gaming balls to be executed, for example, the CPU 102 causes the serial I/F 106 to transmit an instruction signal corresponding to the request signal to the CPU 66 equipped with the control unit 60 of the pachinko gaming machine 1. Upon receiving the instruction signal, the CPU 66 drives the dispenser 59 so as to dispense a predetermined number of gaming balls to the upper tray 22.

When a personal identification of a player is necessary for executing the processing related to the renting of gaming balls, the CPU 102 may cause the LAN controller 104 to transmit an instruction signal corresponding to the request signal to the information managing apparatus 4 via the wiring network 8 in order to refer to personal information of the player and the like, and ask whether to permit the renting of gaming balls or not.

When the request signal is concerned with the processing related to the providing of points necessary for the renting of gaming balls, the CPU 102 causes the LAN controller 104 to transmit an instruction signal corresponding to the request signal to the information managing apparatus 4 via the wiring network 8, and asks whether to permit the providing of points or not.

The information managing apparatus 4 accesses a predetermined terminal provided with a system such as CAFIS (Credit And Finance Information System), for example, determines whether to permit the providing of points or not according to the number of points usable by the player and the like, executes processing necessary for a settlement and the like, and transmits a signal corresponding the result of processing to the wireless communication terminal unit 100. When the number of points usable by the player is stored/managed by the information managing apparatus 4, on the other hand, the information managing apparatus 4 determines whether to permit the providing of points or not, and then transmits a signal corresponding to the result of processing to the wireless communication terminal unit 100. Upon receiving the response signal, the wireless communication terminal unit 100 causes the serial I/F 106 to transmit an instruction signal to the CPU 66 provided with the control unit 60 of the pachinko gaming machine 1. The CPU 66 executes the processing for causing the number display 23 to display a predetermined number of points.

When the detail of the request concerning the request signal is the processing related to the display of data onto the data display 50 according to gaming results, the CPU 102 causes the serial I/F 106 to transmit an instruction signal corresponding to the request signal to the CPU 66 provided with the control unit 60 of the pachinko gaming machine 1. The CPU 66 reads out data based on the gaming results from the RAM 70, transmits thus read data to the data display 50, and causes the data display section 51 of the data display 50 to display data based on the gaming results.

As such, in step S11, the wireless communication terminal unit 100 transmits an instruction signal to the subject pachinko gaming machine 1 or the information managing apparatus 4 according to the detail of the request signal received from the cellular phone 5. As a result, a specific process requested by the player such as the renting of gaming balls, providing of points necessary for renting the gaming balls, and displaying of data onto the data display 50 according to gaming results is executed. The specific process requested for the gaming machine by the request signal is not restricted to the examples mentioned above as a matter of course.

Subsequently, the CPU 102 determines whether or not an additional order request signal is received from the subject device/apparatus (step S14).

When the request signal is a signal requesting the processing related to the renting of gaming balls to execute, examples of the additional order request signal include a signal for causing the display section of the cellular phone 5 to display an image for promoting a password input and a signal for causing the display section of the cellular phone 5 to display an image for promoting an input of the amount of gaming balls to rent. When the request signal is a signal for requesting the processing related to the providing of points necessary for renting gaming balls to be executed, examples of the additional order request signal include a signal for causing the display section of the cellular phone 5 to display an image for promoting a password input and a signal for causing the display section of the cellular phone 5 to display an image for promoting an input of the amount of points to be purchased.

When the request signal is a signal requesting the processing related to the displaying of data onto the data display 50 according to gaming results, examples of the additional order request signal include a signal for causing the display section of the cellular phone 5 to display an image for promoting a choice of a desirable data item and a signal for causing the display section of the cellular phone 5 to display an image for promoting a choice of a gaming machine.

According to such an additional order request signal, an image for promoting an additional order input is displayed on the display section of the cellular phone 5. According to the order represented by such an image, the player operates the cellular phone 5, so as to input an additional order required for proceeding with a specific process. As a result, the specific process required by the player proceeds.

If it is determined in step S14 that an additional order request signal is received from the subject device/apparatus, the CPU 102 transmits an additional order request signal to the cellular phone 5 (step S15). The additional order request signal from the wireless communication terminal unit 100 to the cellular phone 5 can be transmitted as with the above-mentioned response signal.

Subsequently, the CPU 102 determines whether an additional request signal is received from the cellular phone 5 or not (step S16).

When the request signal received in step S10 is a signal requesting the processing related to the renting of gaming balls to be executed, examples of the additional request signal include a signal related to an inputted password and a signal related to the amount of gaming balls rented.

When the request signal received in step S10 is a signal requesting the processing related to the providing of points necessary for renting gaming balls, examples of the additional request signal include a signal related to an inputted password and a signal related to the amount of points purchased.

When the request signal received in step S10 is a signal requesting the processing related to the displaying of data onto the data display 50 according to gaming results, examples of the additional request signal include a signal related to a desirable data item and a signal related to a gaming machine requesting data.

If it is determined in step S16 that no additional request signal is received, the CPU 102 returns the processing to step S15, and transmits the additional order request signal to the cellular phone 5 successively.

If it is determined that the additional request signal is received from the cellular phone 5, the CPU 102 transmits a response signal including the verification image data to the cellular phone 5 (step S17). The processing of step S17 is substantially the same as that of step S11, which has already been explained, and thus will not be explained here. When the processing of step S17 is carried out, and the cellular phone 5 receives the response signal, a verification image based on the verification image data is displayed on the display section of the cellular phone 5. When the cellular phone 5 receives the response signal, a reception completion report signal is transmitted from the cellular phone 5.

Subsequently, the CPU 102 determines whether the reception completion report signal from the cellular phone 5 is received or not (step S18). If it is determined that no reception completion report signal is received, the CPU 102 returns the processing to step S17, and transmits the response signal successively.

If it is determined in step S18 that the reception completion report signal is received, the CPU 102 transmits an instruction signal corresponding to the additional request signal to the subject device/apparatus (step S19). Thus, in step S19, the wireless communication terminal unit 100 transmits an instruction signal to the subject pachinko gaming machine 1 or information managing apparatus 4 according to the detail of the additional request signal received from the cellular phone 5.

As a result, the specific process requested by the player such as the renting of gaming balls, the providing of points necessary for renting the gaming balls, and the displaying of data onto the data display 50 according to gaming results proceeds. The details of the additional order request signal and the details of the additional request signal are not restricted to the above-mentioned examples as a matter of course.

If it is determined in step S14 that no additional order request signal is received from the device/apparatus to be subjected to the request signal or if the processing of step S19 is executed, the CPU 102 determines whether a processing completion report signal is received from the subject device/apparatus or not (step S20). This processing completion report signal is a signal transmitted to the wireless communication terminal unit 100 provided with the pachinko gaming machine 1 when the subject device/apparatus having received the instruction signal in step S13 has completed the process based on the instruction signal.

If it is determined in step S20 that no processing completion report signal is received, the process based on the instruction signal has not been completed in the subject device/apparatus, whereby the CPU 102 returns the processing to step S14.

If it is determined in step S20 that the processing completion report signal is received from the subject device/apparatus, the CPU 102 transmits a response signal including verification image data to the cellular phone 5 (step S21). The processing of step S21 is substantially the same as that of step S11, which has already been explained, and thus will not be explained here. When the processing of step S21 is carried out, and the cellular phone 5 receives a response signal, a verification image based on the verification image data is displayed on the display section of the cellular phone 5. Upon receiving the response signal, the cellular phone 5 transmits a reception completion report signal.

Subsequently, the CPU 102 determines whether the reception completion report signal from the cellular phone 5 is received or not (step S22). If it is determined that no reception completion report signal is received, the CPU 102 returns the processing to step S21, and transmits the response signal successively. If it is determined in step S22 that the reception completion report signal is received, on the other hand, this subroutine is terminated.

During when the subroutine shown in FIG. 7 is executed, the pachinko gaming machine 1 functions as personal information signal determining means for determining whether or not a personal information signal is received from the cellular phone 5 via the receiving section 110, and response signal transmitting means for transmitting a response signal to the cellular phone 5 so as to cause the display section of the cellular phone 5 to display a verification image indicating that the personal information signal is received in the case where the personal information signal determining means determines that the personal information signal is received.

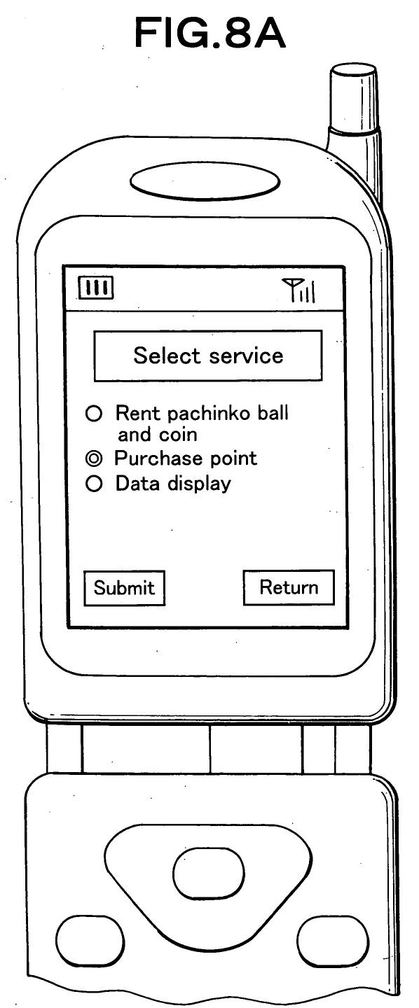

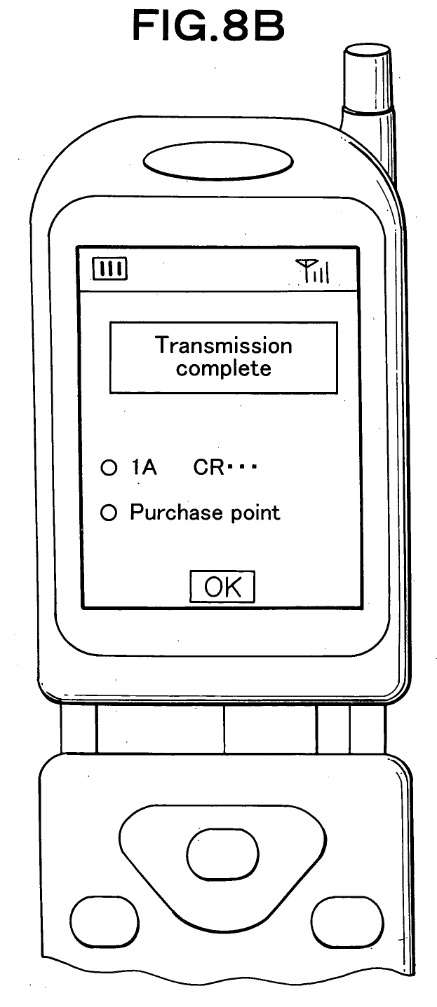

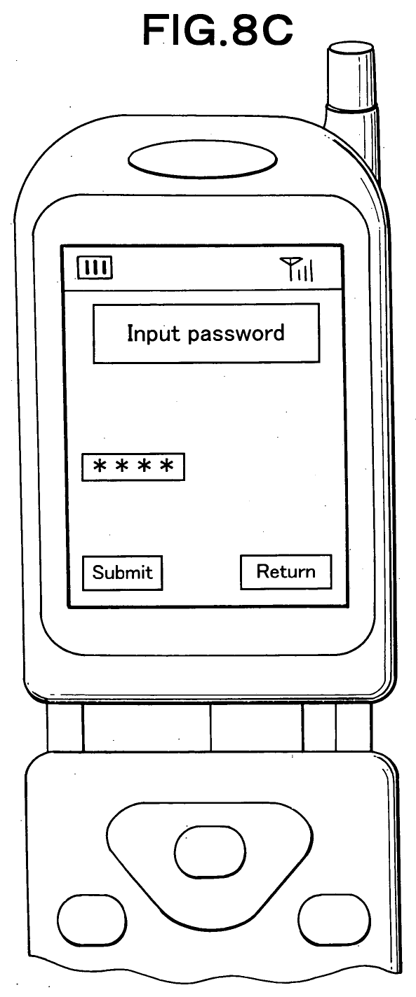

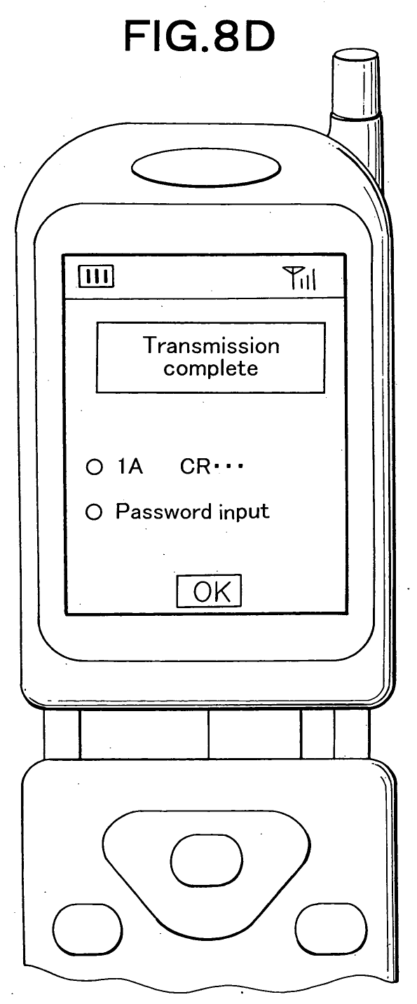

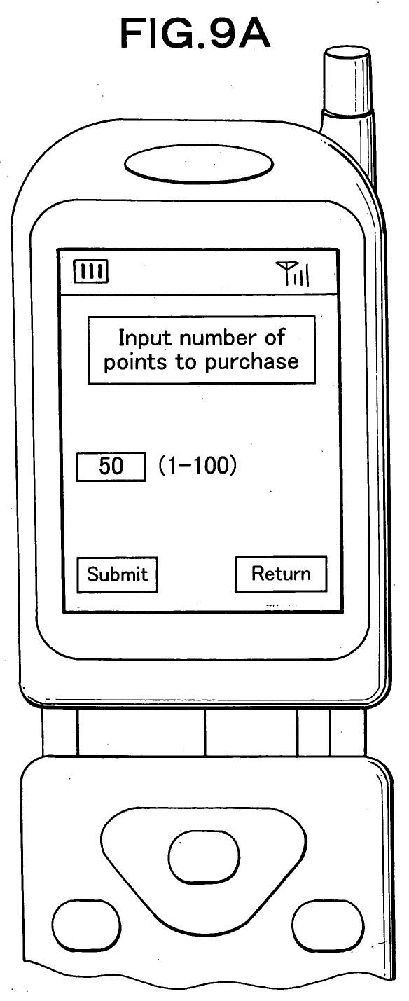

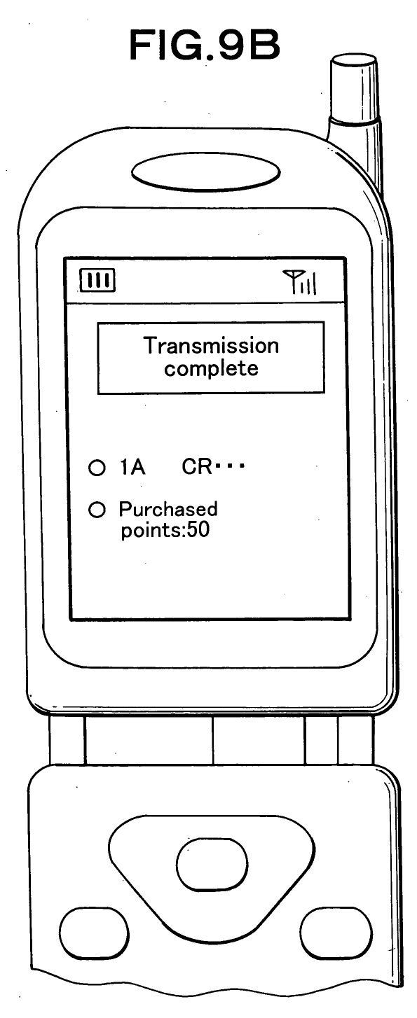

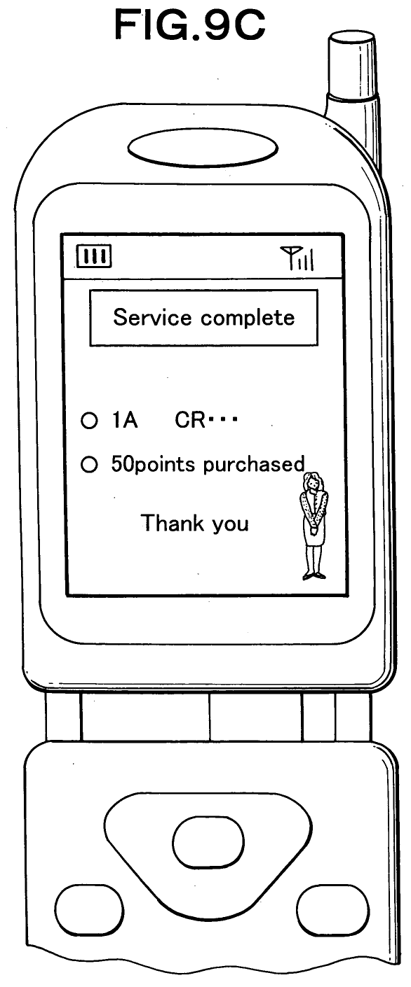

The process carried out until a verification image is displayed on a mobile terminal in the gaming system will now be explained with reference to FIGS. 8A to 8D and 9A to 9C together with images displayed on the display section of the mobile terminal.

FIGS. 8A to 8D and FIGS. 9A to 9C are views schematically showing examples of images displayed on the display section of the cellular phone 5.

First, when a specific kind of software stored in a memory provided with the cellular phone 5 is started as the player inputs an order, a screen image shown in FIG. 8A is displayed on the display section of the cellular phone 5.

Displayed on the upper side of the screen image shown in FIG. 8A is an image indicating an operation procedure stating “Select service.” Displayed at the center of the screen image are images indicating options concerning kinds of service “Rent pachinko ball and coin”, “Purchase point”, and “Data display” successively from the upper side, with respective radio buttons on the left side of the images. Displayed on the lower side of the screen image are images indicating options of “Submit” and “Return”, respectively.

While the screen image shown in FIG. 8A is displayed, the player can choose one kind of service from the options concerning kinds of service by operating the cellular phone 5 so as to input a predetermined order, and thus can transmit a request signal from the cellular phone 5 to the pachinko gaming machine 1.

As explained with reference to FIG. 7, upon receiving a request signal requesting a point to be provided via the receiving section 110 (see step S10), the wireless communication terminal unit 100 provided with the pachinko gaming machine 1 transmits a response signal including verification image data to the cellular phone 5 (see step S11). As a result, the screen image shown in FIG. 8B is displayed on the display section of the cellular phone 5.

The screen image shown in FIG. 8B is an example of verification image displayed on the display section of the cellular phone 5. Namely, an image stating “Transmission complete.” which indicates that the pachinko gaming machine 1 has received a response signal (personal information signal) is displayed on the upper side of the screen image shown in FIG. 8B, whereas an image showing “1A CR . . .” which indicates the number and name of the pachinko gaming machine 1 having received the response signal and an image stating “Purchase point” which indicates the detail of a specific process related to the request signal are displayed at the center of the screen image. In view of the verification image shown in FIG. 8B, the player can easily see that communications were correctly performed, and immediately find the occurrence of erroneous transmissions if any.

When a process related to the providing of points is executed in the subject device/apparatus thereafter, an additional order request signal for causing the display section of the cellular phone 5 to display an image for promoting a password input is transmitted to the cellular phone 5 (see step S15), for example. As a result, the screen image shown in FIG. 8C is displayed on the display section of the cellular phone 5.

An image showing an operation procedure “Input password.” is displayed on the upper side of the screen image shown in FIG. 8C, whereas an image indicating a password input field is shown at the center of the screen image. Displayed on the lower side of the screen image are images of “Submit” and “Return”, respectively.

While the screen image shown in FIG. 8C is displayed, the player can input the password by operating the cellular phone 5 so as to input a predetermined order, and thus can transmit an additional request signal related to the inputted password from the cellular phone 5 to the pachinko gaming machine 1.

Upon receiving the additional request signal related to the inputted password via the receiving section 110 (see step S16), the wireless communication terminal unit 100 provided with the pachinko gaming machine 1 transmits a response signal including verification image data to the cellular phone 5 (see step S17). As a result, the screen image shown in FIG. 8D is displayed on the display section of the cellular phone 5.

The screen image shown in FIG. 8D is an example of verification image displayed on the display section of the cellular phone 5. Namely, an image stating “Transmission complete.” which indicates that the pachinko gaming machine 1 has received a response signal (personal information signal) is displayed on the upper side of the screen image shown in FIG. 8D, whereas an image showing “1A CR . . .” which indicates the number and name of the pachinko gaming machine 1 having received the response signal and an image stating “Password input” which indicates the detail of the process related to the additional request signal are displayed at the center of the screen image.

In view of the verification image shown in FIG. 8D, the player can easily see that communications were correctly performed, and immediately find the occurrence of erroneous transmissions if any.

When a process related to the providing of points is executed in the subject device/apparatus thereafter, an additional request signal for causing the display section of the cellular phone 5 to display an image for promoting an input of the amount of points to be purchased is transmitted to the cellular phone 5 (see step S15), for example.

As a result, the image shown in FIG. 9A is displayed on the display section of the cellular phone 5.

An image indicating an operation procedure “Input number of points to purchase.” is displayed on the upper side of the screen image shown in FIG. 9A, whereas an input field for the number of points to purchase is displayed at the center of the screen image. Displayed on the lower side of the screen image are images of “Submit” and “Return”, respectively.

While the screen image shown in FIG. 9A is displayed, the player can input the number of points to purchase by operating the cellular phone 5 so as to input a predetermined order, and thus can transmit an additional request signal related to the number of points to purchase from the cellular phone 5 to the pachinko gaming machine 1.

Upon receiving the additional request signal related to the number of points to purchase via the receiving section 110 (see step S16), the wireless communication terminal unit 100 provided with the pachinko gaming machine 1 transmits a response signal including verification image data to the cellular phone 5 (see step S17). As a result, the screen image shown in FIG. 9B is displayed on the display section of the cellular phone 5.

The screen image shown in FIG. 9B is an example of verification image displayed on the display section of the cellular phone 5. Namely, an image stating “Transmission complete.” which indicates that the pachinko gaming machine 1 has received a response signal (personal information signal) is displayed on the upper side of the screen image shown in FIG. 9B, whereas an image showing “1A CR . . .” which indicates the number and name of the pachinko gaming machine 1 having received the response signal and an image stating “Purchase points: 50” which indicates the detail of a specific process related to the additional request signal are displayed at the center of the screen image.

In view of the verification image shown in FIG. 9B, the player can easily see that communications were correctly performed, and immediately find the of erroneous transmissions if any.

When the specific process related to the providing of points proceeds is completed after proceeding according to the additional request signal as mentioned above (see step S20), the wireless communication terminal unit 100 provided with the pachinko gaming machine 1 transmits a response signal including verification image data to the cellular phone 5 (see step S21). As a result, the screen image shown in FIG. 9C is displayed on the display section of the cellular phone 5.

The screen image shown in FIG. 9C is an example of the verification image displayed on the display section of the cellular phone 5. Namely, an image stating “Service complete.” which indicates that the specific process is completed is displayed on the upper side of the screen image shown in FIG. 9C, whereas an image showing “1A CR . . .” which indicates the number and name of the pachinko gaming machine 1 in which the specific process is carried out and an image stating “50 points purchased” which indicates the detail of the completed specific process are displayed at the center of the screen image.

Displayed on the lower side of the screen image is an image stating “Thank you.”

In view of the verification image shown in FIG. 9C, the player can easily see that communications were correctly performed in the specified pachinko gaming machine 1. Even if the requested specific process is not carried out correctly, this can be seen immediately. Therefore, necessary measures such as the reporting to a floor staff member of the arcade, for example, can be taken.

Though the examples of verification image are explained with reference to FIGS. 8A to 9C, the verification image in accordance with the present invention is not restricted to the above-mentioned examples as a matter of course. While the above-mentioned examples relate to a case where a verification image corresponding to the details of processing is displayed each time a personal information signal is received, a verification image having the same details may be displayed.

It is not always necessary to display a verification image each time a personal information signal is received. Whether to display a verification image or not may be set according to details of the process requested. The timing for transmitting a response signal is not required to be immediately after receiving a request signal (personal information signal), and may be after executing the process according to the request signal.

Though the gaming system is explained in the case where the gaming machine comprises personal information signal determining means and response signal transmitting means, the information managing apparatus may comprise the personal information signal determining means and response signal transmitting means in the gaming system. Also, the gaming machine and information managing apparatus may comprise the personal information signal determining means and response signal transmitting means, respectively. On the contrary, the information managing apparatus and gaming machine may comprise the personal information signal determining means and response signal transmitting means, respectively.

Though the gaming machines (pachinko gaming machine and slot machine) equipped with the wireless communication terminal unit in accordance with the present invention and the gaming system in an arcade where these gaming machines are placed are explained in detail in the foregoing, the wireless communication terminal unit of the present invention may be provided with various terminals placed in the arcade instead of the gaming machines. When a terminal storing information concerning each gaming machine and information concerning the whole arcade is provided with the wireless communication terminal unit, various kinds of data of each gaming machine can be displayed on the display screen of a cellular phone as requested by the player by transmitting requested information from the cellular phone to the terminal via the wireless communication terminal unit. Specifically, various kinds of data such as the winning ratio and number of jackpots in each gaming machine can be displayed on the screen of the mobile terminal.

When a device functioning as a terminal dedicated to the renting of gaming balls and the like is provided with the wireless communication terminal unit, gaming balls can be rented as requested from a cellular phone or the like as in the case of the pachinko gaming machine 1.

When a money changer functioning as a terminal is provided with the wireless communication terminal unit, a floor staff member and the like can see the number of bills and coins in the money changer, and thus can manage the money changer without going to the money changer.

The wireless communication terminal unit of the present invention can be used not only in the arcade, but also in amusement facilities where game machines and the like are placed, family restaurants, convenience stores, and the like.

(A) In an amusement facility where game machines and the like are placed, the following various developments can be obtained by transmitting/receiving information to/from a game machine equipped with the wireless communication terminal unit via the wireless communication terminal unit wirelessly or by wire.

Preferably, the game machine or the like has a structure to which the wireless communication terminal unit can be attached detachably. This is because the wireless communication terminal unit can easily be mounted or removed, so as to readily respond to the replacement of game machines and gaming machines and layout modifications in the amusement facility. Because of the same reason, terminals placed in family restaurants, convenience stores, and the like which will be explained later preferably have a structure to which the wireless communication terminal unit can detachably be attached.

(1) A game machine which can utilize a point management system issuing a point according to the amount of money for a merchandise or the like purchased, the number of uses of a card, and the like and providing various kinds of service according to the accumulated number of points can perform a predetermined game according to the number of points usable by a person given via a system such as CAFIS (Credit And Finance Information System) by employing a personal identification method, and can increase the number of points owned by the person according to the result of the game.

(2) Even when individual game machines are not connected by wire, information such as how many games are played and how many medals are inserted and dispensed in each game machine can be obtained by wireless communications between the game machine and the information managing apparatus via the wireless communication terminal unit, and the management concerning the balance of the game machine and the like can be carried out.

(3) When the game machine has a program for storing personal records and the like, a personal identification method based on a password and the like can be employed, so as to record the performance and growth of each person stored in the game machine onto a mobile terminal or the like and allow these records to be browsed.

(4) A character grown in the mobile terminal may be moved to a game machine in the amusement facility, and a game using the character can be played.

(5) Game machines having a progressive function in the amusement facility may be connected to each other by a wireless line via the wireless communication terminal unit, so as to be linked to each other. In this case, according to the number of medals bet, medals are stocked onto the progressive function, and a person finishing earlier with a higher role can acquire the stock.

(6) Not only the game program stored in the game machine, but also the operation program stored in the wireless communication terminal unit can be updated upon transmissions/receptions via a wireless line by way of the information managing apparatus and the like.

(7) By employing a proprietary encryption scheme in communications between game machines and between the information managing apparatus and game machine via a wireless or wired line, security functions can be enhanced.

(B) In a restaurant where a terminal for showing various displays is placed at each table or a predetermined location, the following various developments can be obtained by attaching the wireless communication terminal unit to the terminal and carrying out wireless and wired transmissions and receptions.

(1) In a terminal which is set so as to be able to use the above-mentioned point management system, points owned by a user can be used as a coupon or discount ticket according to the number of points usable by the person provided via a system such as CAFIS (Credit And Finance Information System) by employing a personal identification method.

(2) By carrying out wireless communications from a cellular phone via the wireless communication terminal unit with infrared rays, the user can be provided with service or events aimed at associating with the cellular phone.

(3) Employing a personal identification method such as a password, a member identification for the restaurant and the like can be performed, and service points can be checked, for example.

(4) Terminals placed in the restaurant, or the terminals and the information managing apparatus may be connected to each other via a wireless line by way of the wireless communication terminal unit, so as to distribute information to each terminal and cause the terminal to display thus distributed information, whereas users can communicate with each other by transmitting/receiving information between the terminals, and so forth.

(5) Wireless or wired communications via the information managing apparatus and the like can cause each terminal to display daily menus and time limited menus.

(6) By employing a proprietary encryption scheme in communications between terminals and between the terminal and the information managing apparatus via a wireless or wired line, security functions can be enhanced.

(C) In a shop such as a convenience store in which a terminal capable of various displays or the terminal also acting as a cash register is placed at each table or a predetermined location, the following various developments can be obtained by attaching the wireless communication terminal unit to the terminal and carrying out transmissions/receptions wirelessly or by wire.

(1) In a terminal set so as to be able to use the above-mentioned point management system, points owned by a user can be used as a coupon or discount ticket according to the number of points usable by the person provided via a system such as CAFIS (Credit And Finance Information System) by employing a personal identification method.

(2) By carrying out wireless communications from a cellular phone via the wireless communication terminal unit with infrared rays, the user can be provided with service or events aimed at associating with the cellular phone.

(3) Employing a personal identification method such as a password, member identification for the convenience store and the like can be performed, and service points can be checked, for example.

(4) When terminals placed in the shop, or the terminals and the information managing apparatus are connected to each other via a wireless line by way of the wireless communication terminal unit, the sales trend of the whole store can be seen, according to which the management concerning the replacement of merchandises and the like can be carried out.

(5) When terminals placed in the shop, or the terminals and the information managing apparatus are connected to each other via a wired line by way of the wireless communication terminal unit, security functions can be ensured, and high-speed communications can be carried out.

(6) By employing a proprietary encryption scheme in communications between terminals and between the terminal and the information managing apparatus via a wireless or wired line, security functions can be enhanced.

The gaming machine in accordance with this embodiment is applicable not only to the pachinko gaming machine and slot machine, but also to other gaming machines such as poker game machine.

In this embodiment, the wireless communication terminal unit can receive information signals wirelessly from mobile terminals and transmit/receive predetemined information signals to/from terminals, an information managing apparatus, and the like, and thus can construct a system for exchanging information with mobile terminals owned by users of various facilities such as amusement facilities and arcades (pachinko parlors) in such facilities.

Also, by using mobile terminals, users can acquire information concerning the facilities including their own information or information inherent in mobile terminals or gaming machines, and exchange information, whereby the convenience improves greatly.

The wireless communication terminal unit is easy to place and so forth, relatively inexpensive, and unlimited in terms of the location and object of its placement, whereby it can conform to a wide range of use. Therefore, managers of various facilities can easily introduce such a system.

Since the gaming machine in accordance with this embodiment is provided with an attachment to which the wireless communication terminal unit is detachably attachable, the wireless communication terminal unit and gaming machine can be integrated together when connecting the wireless communication terminal unit. Therefore, it is easy to place. Even when the gaming machine is vibrated and so forth, the wireless communication terminal unit is hard to drop. The gaming machine is excellent in terms of aesthetics as well.

With the gaming machine mounted with such a wireless communication terminal unit, players can acquire information concerning the facilities including their own information and information inherent in gaming machines, and can exchange information. For example, the players can rent gaming balls according to their usable number of points, whereby the convenience improves greatly.

### Second Embodiment

The gaming system in accordance with a second embodiment will now be explained with reference to the drawings.

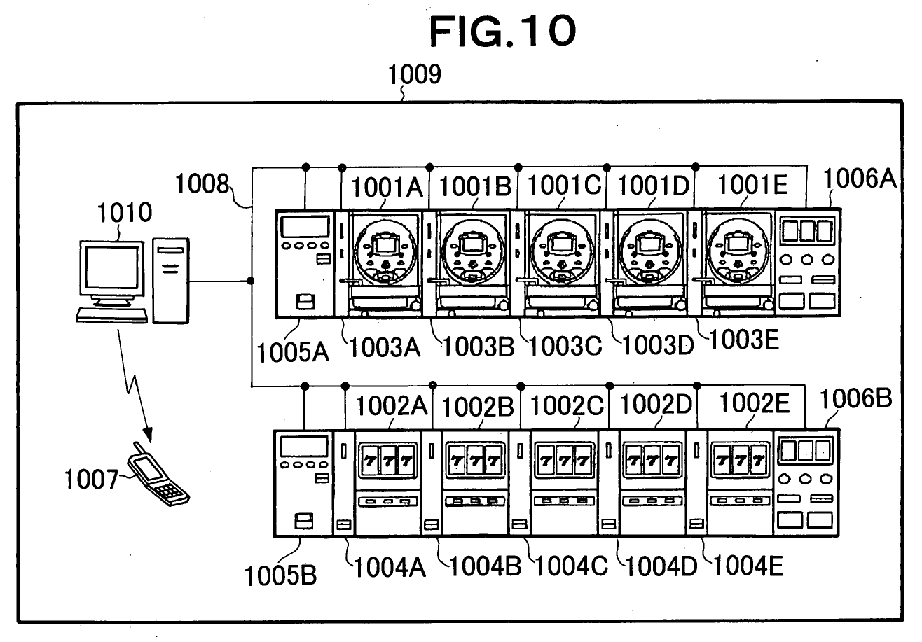

FIG. 10 is a diagram schematically showing an example of the gaming system in accordance with the second embodiment.

In an arcade 1009, a group of five pachinko gaming machines 1001 (1001A to 1001E) and a group of five slot machines 1002 (1002A to 1002E) are arranged in respective rows. Intermediate devices 1003 (1003A to 1003E) are placed on the left side of the respective pachinko gaming machines 1001, whereas intermediate devices 1004 (1004A to 1004E) are placed on the left side of the respective slot machines 1002.

Respective money changers 1005 (1005A and 1005B) are placed on the left side of the intermediate devices 1003A and 1004A, whereas respective card issuing machines 1006 (1006A and 1006B) are placed on the right side of the pachinko gaming machine 1001E and slot machine 1002E.

The intermediate devices 1003 (1003A to 1003E), 1004 (1004A to 1004E), money changers 1005 (1005A to 1005B), and card issuing machines 1006 (1006A and 1006B) are connected to an information managing apparatus 1010 via a wiring network 1008. The intermediate devices 1003, 1004, money changers 1005, and card issuing machines 1006 transmit a notification signal to the information managing apparatus 1010 when the amount of money therein reaches a limit.

The information managing apparatus 1010 can wirelessly communicate with a cellular phone 1007 owned by a floor staff member of the arcade 1009, and transmits an alarm signal to the cellular phone 1007 when the notification signal is received. When the cellular phone 1007 receives this alarm signal, an alarm image is displayed on a display section of the cellular phone 1007.

This alarm image indicates that the amount of money in the arcade-related device (intermediate device 1003, 1004, money changer 1005, and card issuing machine 1006) sending the notification signal has reached the limit, whereby the floor staff member of the arcade can accurately acquire information concerning the amount of money in the arcade-related device in a timely fashion. Therefore, the floor staff member can rapidly deal with the shortage of changes and the like and further prevent the shortage of changes and the like from occurring.

The arcade-related devices are not restricted in particular as long as they are placed in an arcade and can provide a predetermined kind of service in response to insertion of a coin, examples of which include intermediate devices, money changers, and card issuing machines.

The mobile terminal owned by the floor staff member of the arcade is not limited to the cellular phone 1007 as shown in FIG. 10. Examples of the mobile terminal include laptop computers and PDAs (Personal Digital Assistants).

In the present invention, the information managing apparatus is a host computer in a broad sense. Namely, it encompasses not only host computers in a narrow sense (e.g., mainframe computers in vertically distributed systems), but also servers (e.g., workstations and personal computers in horizontally distributed systems). The information managing apparatus may be constituted by an assembly of a plurality of computers.

In the gaming system of the present invention, the arcade-related devices and the information managing apparatus are connected to each other via a communication line. The communication line encompasses not only wired transmission lines, but also wireless transmission lines. Wired communication lines can improve security and realize high-speed communications. On the other hand, wireless communication lines can simplify the wiring operation for layout modifications of arcade-related devices and gaming machines. Communication schemes between the arcade-related devices and gaming machines and the information managing apparatus are not restricted in particular. When frequently modifying the layout of arcade-related devices and gaming machines, for example, the arcade-related devices and information managing apparatus may construct an ad-hoc network (autonomous distributed wireless network). Thus, a simple network can be constructed inexpensively.

In the gaming system of the present invention, the information managing apparatus can wirelessly communicate with the mobile terminal, and transmits an alarm signal to the mobile terminal. Here, the communication medium for the alarm signal is not limited in particular as long as it is wireless, whereby electric waves infrared rays, and the like can be used. Between the information managing apparatus and the mobile terminal, wireless communications may be carried out via a repeater station or base station.

The arcade-related devices used in the gaming system of the present invention will now be explained.

First, an intermediate device which is an example of the arcade-related devices will be explained.

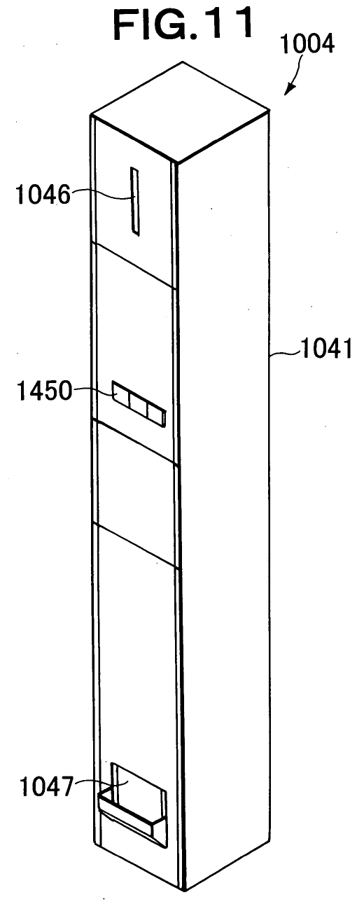

FIG. 11 is a perspective view schematically showing the intermediate device 1004 shown in FIG. 10.

The upper portion in the front face of a housing 1041 of the intermediate device 1004 is formed with a bill insertion slot 1046 through which a 1000-yen bill can be inserted. Provided below the bill insertion slot 1046 is a display device 1450 made of a 7-segment indicator. A medal payout opening 1047 is provided in the lower part of the front face of the housing 1041.

When a 1000-yen bill is inserted into the bill insertion slot 1046, a value of 50 is displayed on the display device 1450. Then, 50 medals are dispensed from the medal payout opening 1047, and a value of 0 is displayed on the display device 1450.

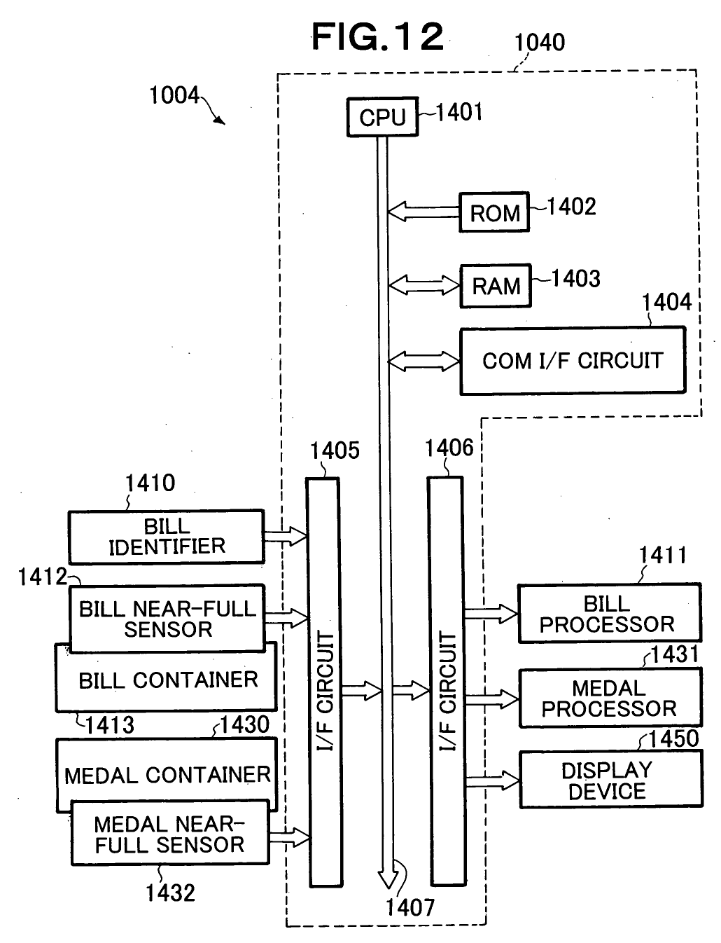

FIG. 12 is a block diagram showing the inner configuration of the intermediate device 1004 shown in FIG. 10.

The intermediate device 1004 comprises a control unit 1040 including a CPU (central processing unit) 1401, a ROM (Read Only Memory) 1402, and a RAM (Random Access Memory) 1403. The control unit 1040 also comprises a communication interface circuit 1404, and can communicate with the information managing apparatus 1010 via a wiring network 1008. By way of an I/O bus 1407, I/Fs (interface circuit groups) 1405, 1406 are connected to the control unit 1040.

Connected to the I/F 1405 are a bill identifier 1410, a bill nearly-full sensor 1412, and a medal nearly-end sensor 1432.

Connected to the I/F 1406 are a bill processor 1411, a medal processor 1431 and the display device 1450.

The bill identifier 1410 determines whether a bill inserted from the bill insertion slot 1046 is a 1000-yen bill or not, and transmits a detection signal to the I/F 1405. The inserted bill is accommodated in a bill stacker 1413.

Upon detecting that the amount of 1000-yen bills in the bill stacker 1413 has reached a predetermined limit (upper limit), i.e., a nearly-full state, the bill nearly-full sensor 1412 transmits a detection signal to the I/F 1405. Specifically, the bill nearly-full sensor 1412 is a sensor such as mechanical and optical sensors, for example, and detects whether a stack of 1000-yen bills in the bill stacker 1413 has reached a predetermined height.

A medal container 1430 contains medals. Upon detecting that the amount of medals in the medal container 1430 has reached a predetermined limit (lower limit), i.e., a nearly-end state, the medal nearly-end sensor 1432 transmits a detection signal to the I/F 1405. Specifically, the medal nearly-end sensor 1432 is a sensor such as mechanical and optical sensors, for example, and detects whether a stack of medals in the medal container 1430 has become lower than a predetermined height.

The control unit 1040 receives detection signals by way of the I/F 1405, carries out arithmetic operations and the like, and transmits, according to results thereof, control signals to devices/apparatus connected to the I/F 1406. According to control signals from the control unit 1040, the bill processor 1411 conveys bills in the intermediate device 1004. According to control signals from the control unit 1040, the medal processor 1431 dispenses medals contained in the medal container 1430 to the medal payout opening 1047. The number of medals corresponding to the inserted bill is displayed as a number on the display device 1450.

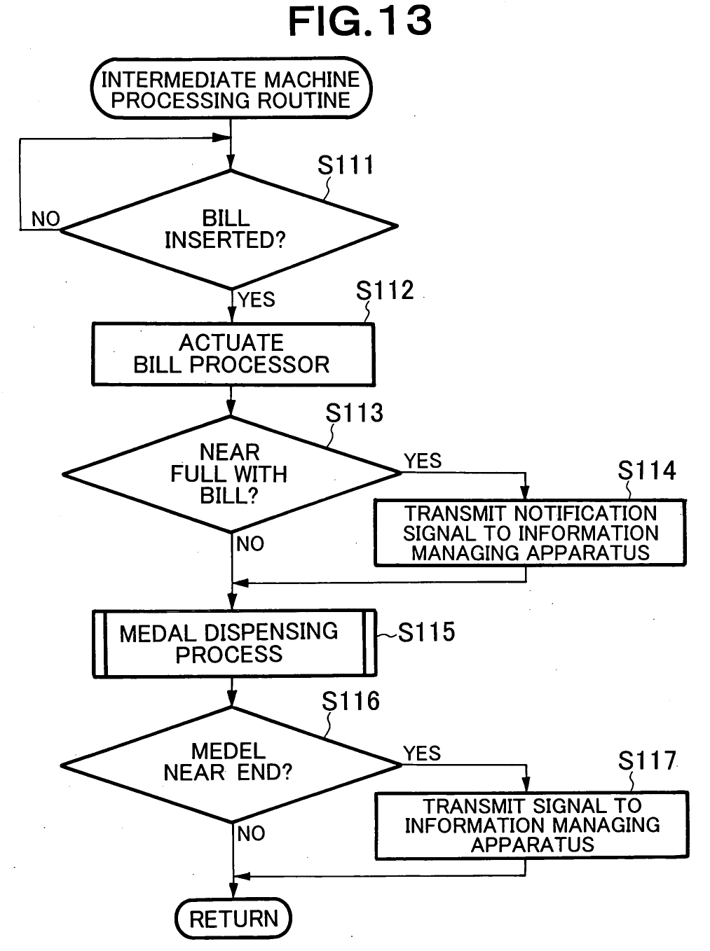

FIG. 13 is a flowchart showing a subroutine executed in the intermediate device 1004 shown in FIG. 10. This subroutine is executed while being called at a predetermined timing from a main routine executed beforehand.

First, the CPU 1401 determines whether a 1000-yen bill is inserted from the bill insertion slot 1046 or not (step S111). Namely, the CPU 1401 determines whether a detection signal from the bill identifier 1410 is received or not.

If it is determined that no 1000-yen bill is inserted from the bill insertion slot 1046, the CPU 1401 returns the processing to step S111.

If it is determined in step S111 that a 1000-yen bill is inserted from the bill insertion slot 1046, on the other hand, the CPU 1401 transmits a control signal so as to actuate the bill processor 1411, thereby carrying out a process of accommodating the inserted 1000-yen bill into the bill stacker 1413 (step S112).

Subsequently, the CPU 1401 determines whether the bill stacker 1413 is nearly full with 1000-yen bills or not (step S113). Namely, the CPU 1401 determines whether a detection signal is received from the bill nearly-full sensor 1412 or not, thereby determining whether the bill stacker 1413 is nearly full with 1000-yen bills or not.

If it is determined in step S113 that the bill stacker 1413 is nearly full with 1000-yen bills, the CPU 1401 causes the communication interface circuit 1404 to transmit a notification signal to the information managing apparatus 1010 via the wiring network 1008 (step S114).

Here, the intermediate device 1004 functions as notification signal transmitting means for transmitting a notification signal to the information managing apparatus 1010 when the amount of money in the machine reaches a limit.

If it is determined in step S113 that the bill stacker 1413 is not nearly full with 1000-yen bills or if the processing of step S114 is executed, the CPU 1401 carries out a process of dispensing medals (step S115). Namely, the CPU 1401 actuates the medal processor 1431 so as to carry out a process of dispensing a predetermined number (e.g., 50) medals from the medal container 1430 to the medal payout opening 1047, and a process of variably displaying a number corresponding to the number of dispensed medals onto the display device 1450.

Next, the CPU 1401 determines whether medals are in the nearly-end state in the medal container 1430 or not (step S116). Namely, the CPU 1401 determines whether a detection signal is received from the medal nearly-end sensor 1412 or not, thereby determining whether the medals are in the nearly-end state or not.

If it is determined in step S116 that the medals are in the nearly-end state, the CPU 1401 causes the communication interface circuit 1404 to transmit a predetermined signal to the information managing apparatus 1010 via the wiring network 1008 (step S117).

If it is determined in step S116 that the medals are not in the nearly-end state or if the process of step S117 is executed, this subroutine is terminated.

Thus, the intermediate device 1004 transmits to the information managing apparatus 1010 a notification signal when the bill stacker 1413 is nearly full with 1000-yen bills, and a predetermined signal when the medals are in the nearly-end state in the medal container 1430.

Then, processes corresponding to these signals are executed in the information managing apparatus 1010. These processes will be explained later.

A money changer, which is an example of the arcade-related devices, will now be explained.

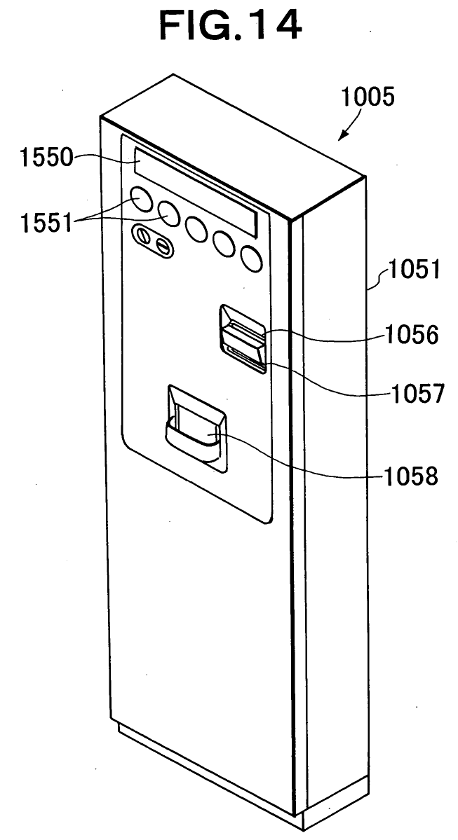

FIG. 14 is a perspective view schematically showing the money changer 1005 shown in FIG. 10.

A display device 1550 is disposed in the upper part of the front face of a housing 1051 of the money changer 1005, whereas an input device 1551 composed of a plurality of buttons is disposed therebelow.

Below the input device 1551, a bill insertion slot 1056 into which 1000-, 5000-, and 10000-yen bills can be inserted, and a bill payout opening 1057 for dispensing bills after money changing are provided. A coin payout opening 1058 for dispensing coins after money changing is disposed therebelow.

When a bill is inserted into the bill insertion slot 1056, the value of the inserted bill is displayed on the display device 1550. When the user pushes one of the buttons in the input device 1551, money changing is carried out, and bills after the money changing are dispensed from the bill payout opening 1057, or coins after the money changing are dispensed from the coin payout opening 1058.

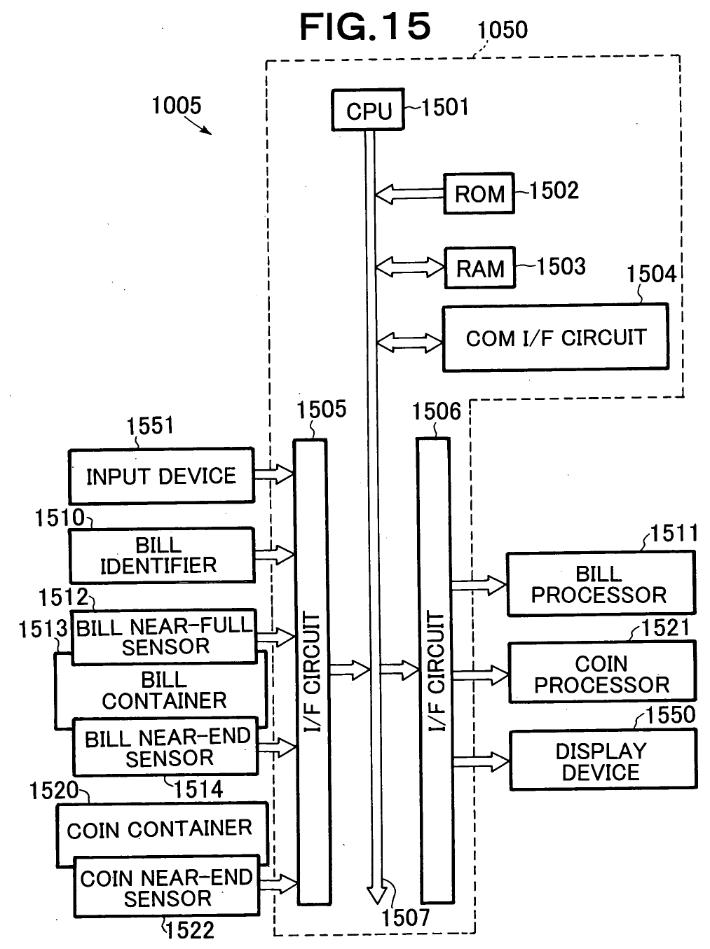

FIG. 15 is a block diagram showing the inner configuration of the money changer 1005 shown in FIG. 10. The money changer 1005 comprises a control unit 1050 including a CPU 1501, a ROM 1502, and a RAM 1503. The control unit 1050 comprises a communication interface circuit 1504, and can communicate with the information managing apparatus 1010 via the wiring network 1008. By way of an I/O bus 1507, I/Fs 1505, 1506 are connected to the control unit 1050.

Connected to the I/F 1505 are the input device 1551, a bill identifier 1510, a bill nearly-full sensor 1512, a bill nearly-end sensor 1514, and a coin nearly-end sensor 1522.

Connected to the I/F 1506 are a bill processor 1511, a coin processor 1512, and the display device 1550.

The input device 1551 is constituted by a plurality of buttons. By pressing one of the buttons, the player can choose a money changing method. When the input device 1551 is operated, an input signal is transmitted to the I/F 1505.

The bill identifier 1510 determines whether a bill is inserted from the bill insertion slot 1056 or not, identifies the types and values of the inserted bill, and transmits a detection signal to the I/F 1505. A bill stacker 1513 stores inserted bills one type to another.

The bill nearly-full sensor 1512 is similar to the bill nearly-full sensor 1412 mentioned above, and transmits a detection signal to the I/F 1505 upon detecting that the amount of bills in the bill stacker 1513 has reached a predetermined limit (upper limit), i.e., a nearly-full state.

On the other hand, the bill nearly-end sensor 1514 transmits a detection signal to the I/F 1505 upon detecting that the amount of bills in the bill stacker 1513 has reached a predetermined limit (lower limit), i.e., a nearly-end state. Specifically, the bill nearly-end sensor 1514 is a sensor such as mechanical and sensors, for example, and detects whether a stack of bills in the bill stacker 1513 has become lower than a predetermined height.

A coin container 1520 contains coins one type to another. Upon detecting that the amount of coins in the coin container 1520 has reached a predetermined limit (lower limit), i.e., a nearly-end state, the coin nearly-end sensor 1522 transmits a detection signal to the I/F 1505. Specifically, the coin nearly-end sensor 1522 is a sensor such as mechanical and optical sensors, for example, and detects whether a stack of coins in the coin container 1520 has become lower than a predetermined height.

The control unit 1050 receives various signals mentioned above via the I/F 1505, carries out arithmetic operations and the like, and transmits, according to results thereof, control signals to devices/apparatus connected to the I/F 1506.

According to control signals from the control unit 1050, the bill processor 1511 conveys bills in the money changer 1005, and dispenses bills from the bill stacker 1513 to the bill payout opening 1057. According to control signals from the control unit 1050, the coin processor 1521 conveys coins in the money changer 1005, and dispenses coins contained in the coin container 1520 to the coin payout opening 1058. The value of the inserted bills is displayed onto the display device 1550.

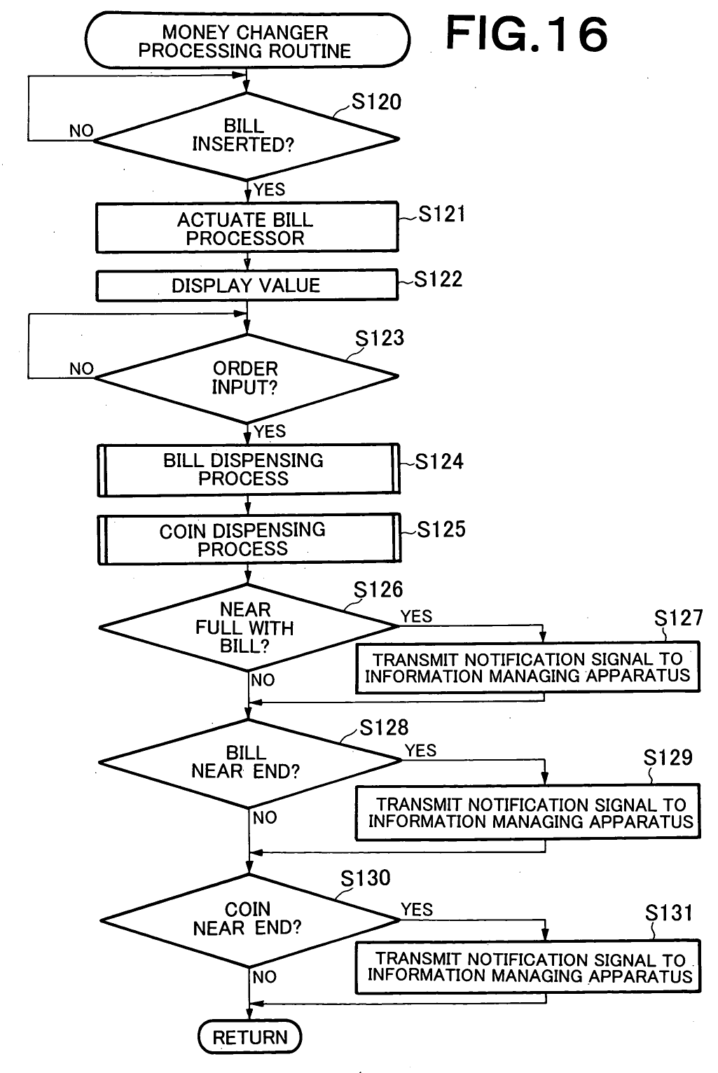

FIG. 16 is a flowchart showing a subroutine executed in the money changer 1005 shown in FIG. 10. This subroutine is executed while being called at a predetermined timing from the main routine executed beforehand.

First, the CPU 1501 determines whether a bill is inserted from the bill insertion slot 1056 or not (step S120). The bill identifier 1510 determines whether a bill is inserted from the bill insertion slot 1056 or not. If a bill is inserted, the bill identifier 1510 identifies the types and values of the inserted bill, and transmits a detection signal to the CPU 1501. The CPU 1501 determines whether the detection signal is received or not, thereby determining whether the bill is inserted or not.

If it is determined that no bill is inserted from the bill insertion slot 1056, the CPU 1501 returns the processing to step S120.

If it is determined in step S120 that a bill is inserted from the bill insertion slot 1056, on the other hand, the CPU 1501 transmits a control signal so as to actuate the bill processor 1511, thereby carrying out a process of accommodating the inserted bill according to its types and values into the bill stacker 1513 (step S121).

Subsequently, the CPU 1501 carries out a process of causing the display device 1550 to display the value of the inserted bill (step S122). Then, the CPU 1501 determines whether an order from the player is inputted or not (step S123). Namely, the CPU 1501 determines whether an input signal from the input device 1551 is received or not, thereby determining whether an order from the player is inputted or not.

If it is determined that no order from the player is inputted, the CPU 1501 returns the processing to step S123.

If it is determined that an order from the player is inputted, the CPU 1501 carries out a bill dispensing process (step S124) and a coin dispensing process (step S125). Namely, according to the input signal, the CPU 1501 transmits a control signal so as to actuate the bill processor 1511 and/or coin processor 1512, so as to carry out a process of dispensing a predetermined number of bills from the bill stacker 1513 to the bill payout opening 1057 and a process of dispensing a predetermined number of coins from the coin container 1520 to the coin payout opening 1058.

Subsequently, the CPU 1501 determines whether the bill stacker 1513 is nearly full with bills or not (step S126). Namely, the CPU 1501 determines whether a detection signal is received from the bill nearly-full sensor 1512 or not, thereby determining whether the bill stacker 1513 is nearly full with bills or not.

If it is determined in step S126 that the bill stacker 1513 is nearly full with bills, the CPU 1501 causes the communication interface circuit 1504 to transmit a notification signal to the information managing apparatus 1010 via the wiring network 1008 (step S127).

Here, the money changer 1005 functions as notification signal transmitting means for transmitting a notification signal to the information managing apparatus 1010 when the amount of money in the machine reaches a limit.

If it is determined in step S126 that the bill stacker 1513 is not nearly full with bills or if the processing of step S127 is executed, the CPU 1501 determines whether the bills are in a nearly-end state in the bill stacker 1513 or not (step S128). Namely, the CPU 1501 determines whether a detection signal is received from the bill nearly-end sensor 1514 or not, thereby determining if the bills are in the nearly-end state or not.

If it is determined in step S128 that the bills are in the nearly-end state, the CPU 1501 causes the communication interface circuit 1504 to transmit a notification signal to the information managing apparatus 1010 via the wiring network 1008 (step S129).

Here, the money changer 1005 functions as notification signal transmitting means for transmitting a notification signal to the information managing apparatus 1010 when the amount of money in the machine reaches a limit.

If it is determined in step S128 that the bills are not in the nearly-end state or if the processing of step S129 is executed, the CPU 1501 determines whether coins are in a nearly-end state in the coin container 1520 or not (step S130). Namely, the CPU 1501 determines whether a detection signal is received from the coin nearly-end sensor 1522 or not, thereby determining whether the coins are in the nearly-end state or not.

If it is determined in step S130 that the coins are in the nearly-end state, the CPU 1501 causes the communication interface circuit 1504 to transmit a notification signal to the information managing apparatus 1010 via the wiring network 1008 (step S131).

Here, the money changer 1005 functions as notification signal transmitting means for transmitting a notification signal to the information managing apparatus 1010 when the amount of money in the machine reaches a limit.

If it is determined in step S130 that the coins are not in the nearly-end state or if the processing of step S131 is executed, this subroutine is terminated.

Thus, the money changer 1005 transmits to the information managing apparatus 1010 a notification signal when the bill stacker 1513 is nearly full with bills or the bills are in the nearly-end state therein, or when the coins are in the nearly-end state in the coin container 1520.

Then, processes corresponding to these signals are executed in the information managing apparatus 1010. These processes will be explained later.

A card issuing machine, which is an example of the arcade-related devices, will now be explained.

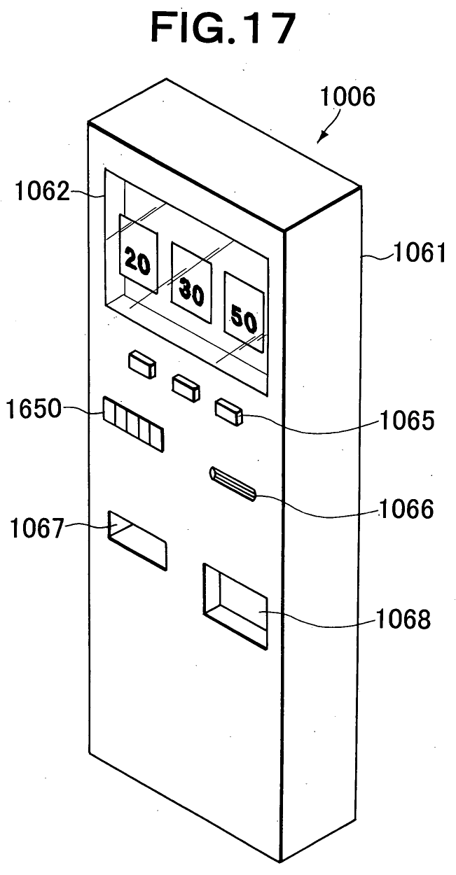

FIG. 17 is a perspective view schematically showing the card issuing machine 1006 shown in FIG. 10.

In the upper part of the front face of a housing 1061 of the card issuing machine 1006, three kinds of prepaid cards are displayed as samples. Namely, 2000-, 3000-, and 5000-yen prepaid cards are successively displayed from the left. An input device 1651 constituted by three buttons is disposed therebelow. The three buttons correspond to the respective kinds of prepaid cards. By pressing one of the three buttons, the player can purchase a desirable kind of prepaid card.

Disposed below the input device 1651 is a display device 1650. Also provided is a bill insertion slot 1066 into which 1000-, 5000-, and 10000-yen bills can be inserted. Further, a bill payout opening 1067 for dispensing bills and a card issuing opening 1068 for issuing cards are provided therebelow.

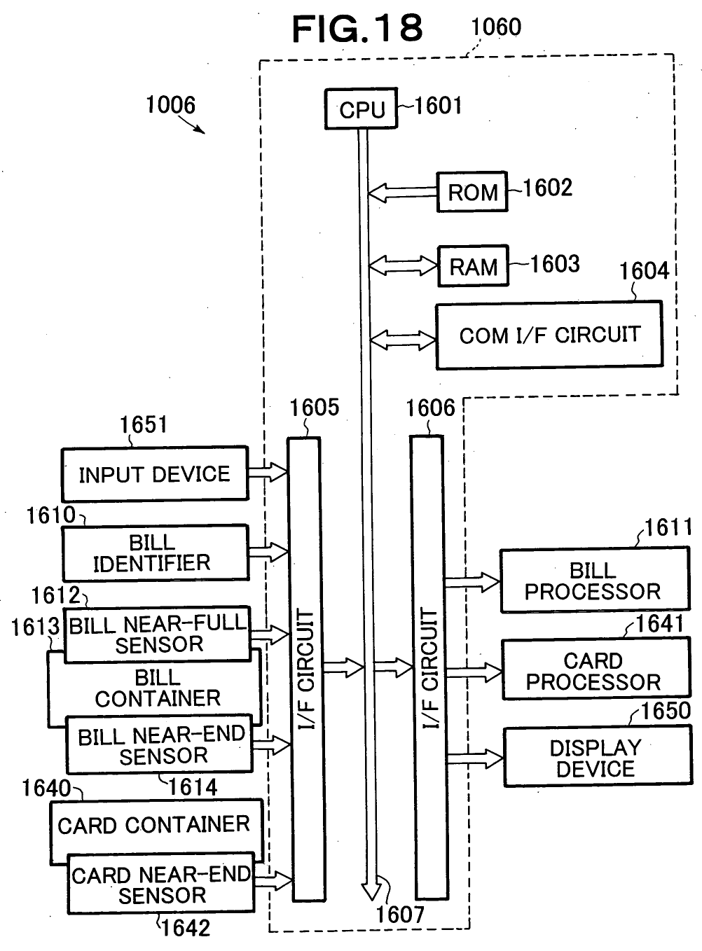

FIG. 18 is a block diagram showing the inner configuration of the card issuing machine 1006 shown in FIG. 10. The card issuing machine 1006 comprises a control unit 1060 including a CPU 1601, a ROM 1602, and a RAM 1603. The control unit 1060 comprises a communication interface circuit 1604, and can communicate with the information managing apparatus 1010 via the wiring network

By way of an I/O bus 1607, I/Fs 1605, 1606 are connected to the control unit 1060.

Connected to the I/F 1605 are the input device 1651, a bill identifier 1610, a bill nearly-full sensor 1612, a bill nearly-end sensor 1614, and a card nearly-end sensor 1642.

Connected to the I/F 1606 are a bill processor 1611, a card processor 1641, and a display device 1650.

The input device 1651 is constituted by three buttons. By pressing one of the buttons, the player can choose a desirable prepaid card. When the input device 1651 is operated, an input signal is transmitted to the I/F 1605.

The bill identifier 1610 determines whether a bill is inserted from the bill insertion slot 1066 or not, identifies the types and values of the inserted bill if any, and then transmits a detection signal to the I/F 1605. A bill stacker 1613 stores inserted bills one type to another.

The bill nearly-full sensor 1612 is similar to the bill nearly-full sensor 1412 mentioned above, and transmits a detection signal to the I/F 1605 upon detecting that the amount of bills in the bill stacker 1613 has reached a predetermined limit (upper limit), i.e., a nearly-full state.

On the other hand, the bill nearly-end sensor 1614 is similar to the bill nearly-end sensor 1514 mentioned above, and transmits a detection signal to the I/F 1605 upon detecting that the amount of bills in the bill stacker 1613 has reached a predetermined limit (lower limit), i.e., a nearly-end state.

A card container 1640 contains prepaid cards one type to another. Upon detecting that the amount of cards in the card container 1640 has reached a predetermined limit (lower limit), i.e., a nearly-end state, the card nearly-end sensor 1642 transmits a detection signal to the I/F 1605. Specifically, the card nearly-end sensor 1642 is a sensor such as mechanical and optical sensors, for example, and detects whether a stack of cards in the card container 1640 has become lower than a predetermined height.

The control unit 1060 receives various signals mentioned above via the I/F 1605, carries out arithmetic operations and the like, and transmits, according to results thereof, control signals to devices/apparatus connected to the I/F 1606.

According to control signals from the control unit 1060, the bill processor 1611 conveys cards in the card issuing machine 1006, and dispenses bills from the bill stacker 1613 to the bill payout opening 1067. According to control signals from the control unit 1060, the card processor 1641 dispenses cards contained in the card container 1640 to the card issuing opening 1068. The value of the inserted bills is displayed onto the display device 1650.

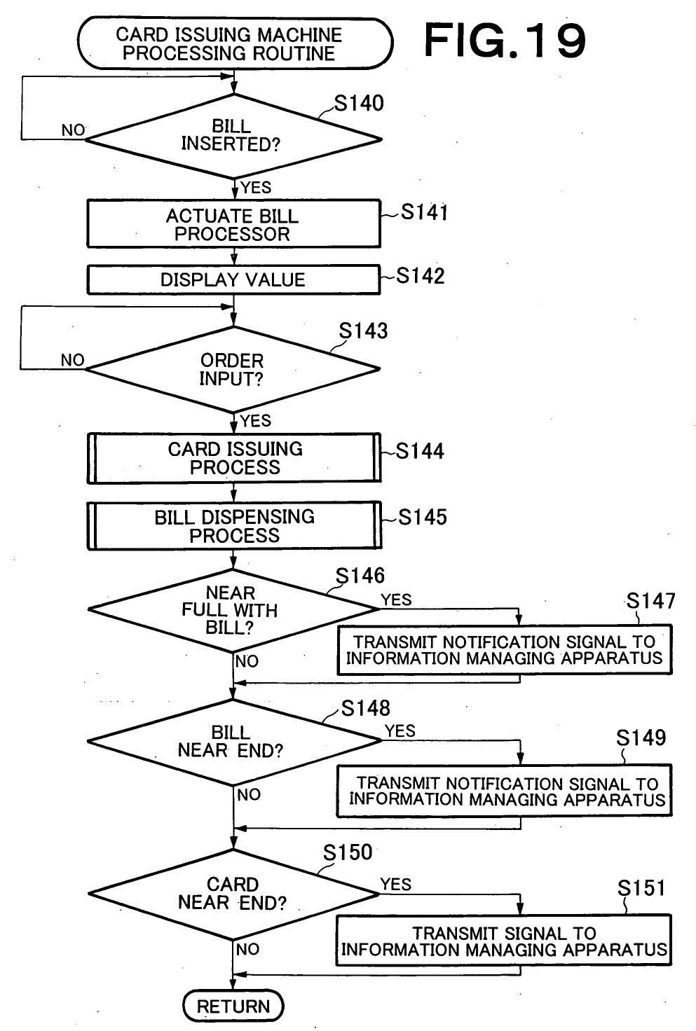

FIG. 19 is a flowchart showing a subroutine executed in the card issuing machine 1006 shown in FIG. 10. This subroutine is executed while being called at a predetermined timing from the main routine executed beforehand.

First, the CPU 1601 determines whether a bill is inserted from the bill insertion slot 1066 or not (step S140). The bill identifier 1610 determines whether a bill is inserted from the bill insertion slot 1066 or not. If a bill is inserted, the bill identifier 1610 identifies the types and values of the inserted bill, and transmits a detection signal to the CPU 1601. The CPU 1601 determines whether the detection signal is received or not, thereby determining whether the bill is inserted or not.

If it is determined that no bill is inserted from the bill insertion slot 1066, the CPU 1601 returns the processing to step S140.

If it is determined in step S140 that a bill is inserted from the bill insertion slot 1066, on the other hand, the CPU 1601 transmits a control signal so as to actuate the bill processor 1611, thereby carrying out a process of accommodating the inserted bill according to its types and values into the bill stacker 1613 (step S141).

Subsequently, the CPU 1601 carries out a process of causing the display device 1650 to display the value of the inserted bill (step S142). Then, the CPU 1601 determines whether an order from the player is inputted or not (step S143). Namely, the CPU 1601 determines whether an input signal from the input device 1651 is received or not, thereby determining whether an order from the player is inputted or not.

If it is determined that no order from the player is inputted, the CPU 1601 returns the processing to step S143.

If it is determined that an order from the player is inputted, the CPU 1601 carries out a card issuing process (step S144). Namely, according to the input signal, the CPU 1601 transmits a control signal so as to actuate the card processor 1641, thereby carrying out a process of dispensing a predetermined kind of card from the card container 1640 to the card issuing opening 1068.

Subsequently, the CPU 1601 carries out a bill dispensing process (step S145). Namely, according to the input signal, the CPU 1601 transmits a control signal so as to actuate the bill processor 1611, thereby carrying out a process of dispensing a predetermined number of bills from the bill stacker 1613 to the bill payout opening 1067. When the value of inserted bill and the value of prepaid card coincide with each other, there is no need to dispense bills, whereby the processing of step S145 is not carried out. When carrying out the processing of step S144 or S145, the CPU 1601 carries out a process of changing the value of money displayed on the display device 1650.

Subsequently, the CPU 1601 determines whether the bill stacker 1613 is nearly full with bills or not (step S146). Namely, the CPU 1601 determines whether a detection signal is received from the bill nearly-full sensor 1612 or not, thereby determining whether the bill stacker 1613 is nearly full with bills or not. If it is determined in step S146 that the bill stacker 1613 is nearly full with bills, the CPU 1601 causes the communication interface circuit 1604 to transmit a notification signal to the information managing apparatus 1010 via the wiring network 1008 (step S147).

Here, the card issuing machine 1006 functions as notification signal transmitting means for transmitting a notification signal to the information managing apparatus 1010 when the amount of money in the machine reaches a limit.

If it is determined in step S146 that the bill stacker 1613 is not nearly full with bills or if the processing of step S147 is executed, the CPU 1601 determines whether the bills are in a nearly-end state in the bill stacker 1613 or not (step S148). Namely, the CPU 1601 determines whether a detection signal is received from the bill nearly-end sensor 1614 or not, thereby determining if the bills are in the nearly-end state or not.

If it is determined in step S148 that the bills are in the nearly-end state, the CPU 1601 causes the communication interface circuit 1604 to transmit a notification signal to the information managing apparatus 1010 via the wiring network 1008 (step S149).

Here, the card issuing machine 1006 functions as notification signal transmitting means for transmitting a notification signal to the information managing apparatus 1010 when the amount of money in the machine reaches a limit.

If it is determined in step S148 that the bills are not in the nearly-end state or if the processing of step S149 is executed, the CPU 1601 determines whether prepaid cards are in a nearly-end state in the card container 1640 or not (step S150). Namely, the CPU 1601 determines whether a detection signal is received from the card nearly-end sensor 1642 or not, thereby determining whether the prepaid cards are in the nearly-end state or not.

If it is determined in step S150 that the prepaid cards are in the nearly-end state, the CPU 1601 causes the communication interface circuit 1604 to transmit a notification signal to the information managing apparatus 1010 via the wiring network 1008 (step S151).

If it is determined in step S150 that the prepaid cards are not in the nearly-end state or if the processing of step S151 is executed, this subroutine is terminated.

Thus, the card issuing machine 1006 transmits to the information managing apparatus 1010 a notification signal when the bill stacker 1613 is nearly full with bills or the bills are in the nearly-end state therein, and a predetermined signal when the prepaid cards are in the nearly-end state in the card container 1640.

Then, processes corresponding to these signals are executed in the information managing apparatus 1010. These processes will be explained later.

The information managing apparatus used in the gaming system of the present invention will now be explained.

The information managing apparatus of the present invention has a configuration similar to that of the information managing apparatus used in the gaming system of the present invention, and thus will be explained together therewith.

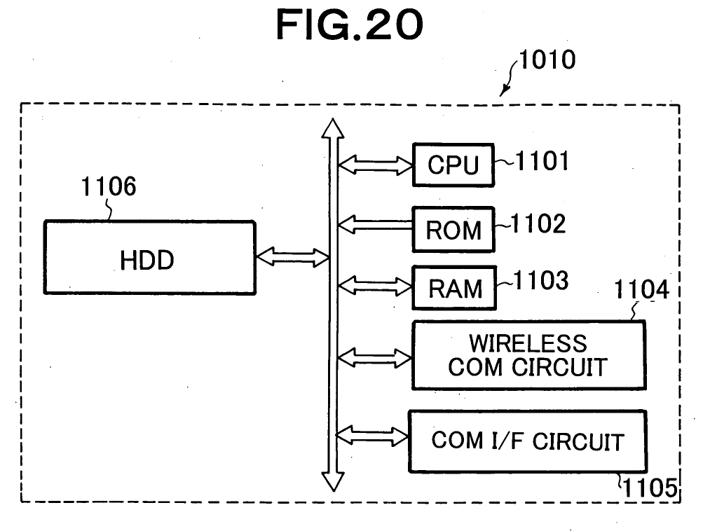

FIG. 20 is a block diagram showing the inner configuration of the information managing apparatus 1010 shown in FIG. 10. The information managing apparatus 1010 is constituted by a CPU 1101, a ROM 1102, a RAM 1103, a wireless communication circuit 1104, a communication interface circuit 1105, and a hard disk drive 1106.

The hard disk drive 1106 stores a program for communicating with the intermediate devices 1003, 1004, money changer 1005, and card issuing machine 1006, which are arcade-related devices. The hard disk drive 1106 also stores a program for communicating with the cellular phone 1007 owned by a floor staff member of the arcade 1009, and data (e.g., a phone number or mail address related to the cellular phone 1007) necessary for communications. The hard disk drive 1106 further stores a program for generating an alarm signal to be transmitted to the cellular phone 1007 and the like.

The wireless communication circuit 1104 is used for wirelessly communicating with the cellular phone 1007 owned by the floor staff member of the arcade 1009, whereas the communication interface circuit 1105 is used for communicating with the intermediate devices 1003, 1004, money changer 1005, and card issuing machine 1006 via the wiring network 1008.

Upon receiving a notification signal from the intermediate device 1003, 1004 money changer 1005, or card issuing machine 1006 via the wiring network 1008 by way of the communication interface circuit 1105, the information managing apparatus 1010 causes the wireless communication circuit 1104 to transmit an alarm signal to the cellular phone 1007.

The alarm signal may include data to become an alarm image (hereinafter also referred to as alarm image data). In this case, the alarm image data is stored in the hard disk drive 1106. The alarm image data includes not only vector image data and raster image data, but also data composed of a markup language such as HTML (Hyper Text Markup Language), for example.

The alarm image data may be stored beforehand in a memory provided with the cellular phone 1007, so that the alarm image can be displayed on the display section of the cellular phone 1007 when the cellular phone 1007 receives the alarm signal.

Preferably, in the present invention, the alarm image includes an image indicating the position of the arcade-related device (e.g., intermediate device 1003, 1004, money changer 1005, or card issuing machine 1006) sending the notification signal. This makes it possible to easily see the position of the arcade-related device whose amount of money reaches a limit, so that the shortage of changes and the like can be mended more rapidly and can be more reliably prevented from occurring.

To the information managing apparatus 1010, a notification signal is transmitted from the intermediate devices 1003, 1004, money changer 1005, or card issuing machine 1006, and a predetermined signal is transmitted when gaming media (gaming balls, medals, and the like) attain a nearly-end state in the intermediate device 1003 or 1004 or when prepaid cards attain a nearly-end state in the card issuing machine 1006.

A process executed in the information managing apparatus 1010 upon receiving these signals will now be explained.

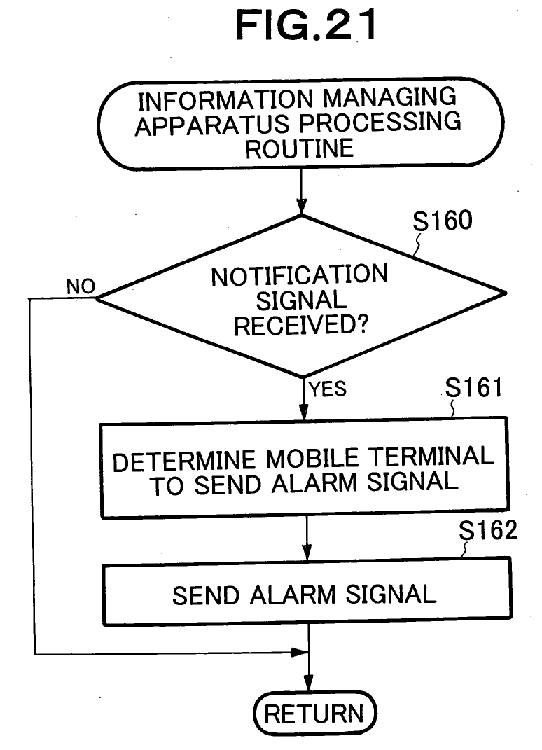

FIG. 21 is a flowchart showing a subroutine executed in the information managing apparatus 1010 shown in FIG. 10. This subroutine is executed while being called at a predetermined timing from a main routine executed beforehand.

First, the CPU 1101 determines whether or not a notification signal is received by the communication interface circuit 1104 via the wiring network 1008 from the intermediate device 1003, 1004, money changer 1005, or card issuing machine 1006 (step S160). Here, it may also be determined whether or not a predetermined signal transmitted from the intermediate device 1003 or 1004 when gaming media (gaming balls, medals, and the like) attain a nearly-end state or a predetermined signal transmitted from the card issuing machine 1006 when prepaid cards attain a nearly-end state is received. Here, the information managing apparatus 1010 functions as notification signal receiving means for receiving a notification signal.

If it is determined in step S160 that no notification signal is received, this subroutine is terminated. If it is determined in step S160 that a notification signal is received, on the other hand, the CPU 1601 determines the cellular phone 1007 to send an alarm signal (step S161). The processing of step S161 is carried out according to data (e.g., the phone number or mail address related to the cellular phone 1007 and the like) necessary for communications stored in the hard disk drive 1106. Data concerning floor staff member on duty for each business day may be stored beforehand in the hard disk 1106, and the processing of step S161 may be carried out according to this data.

Subsequently, the CPU 1101 causes the wireless communication circuit 1104 to transmit an alarm signal including alarm image data to the cellular phone 1007 (step S162). When the alarm image data is stored in the hard disk drive 1106 of the information managing apparatus 1010, the CPU 1101 reads necessary alarm image data from the hard disk drive 1106, and transmits the alarm signal to the cellular phone 1007 together with the alarm image data. When the alarm image data is stored in the memory of the cellular phone 1007 beforehand, the CPU 1101 causes the wireless communication circuit 1104 to transmit only the alarm signal to cellular phone 1007.

When the processing of step S162 is carried out, so that the cellular phone 1007 receives the alarm signal, an alarm image based on the alarm image data is displayed onto the display section of the cellular phone 1007.

Here, the information managing apparatus 1010 functions as alarm signal transmitting means which, upon receiving a notification signal, transmits an alarm signal to the cellular phone 1007 in order to cause the display section of the cellular phone 1007 to display an alarm image indicating that the amount of money in the arcade-related device sending the notification signal has reached a limit.

When it is determined in step S160 that a predetermined signal is received, an alarm signal may be transmitted to the cellular phone 1007 in step S162. This also makes it possible to provide a floor staff member of the arcade 1009 with information concerning the amount of gaming media in the intermediate device 1003 or 1004 and the amount of prepaid cards in the card issuing machine 1006 in an accurate and timely fashion. As a result, the floor staff member of the arcade 1009 can rapidly mend the shortage of gaming media in the intermediate device 1003 or 1004, the shortage of prepaid cards in the card issuing machine 1006, and the like.

This subroutine is terminated when step S162 is executed.

Images displayed on the display section of the cellular phone 1007 by the gaming system of the present invention will now be explained.

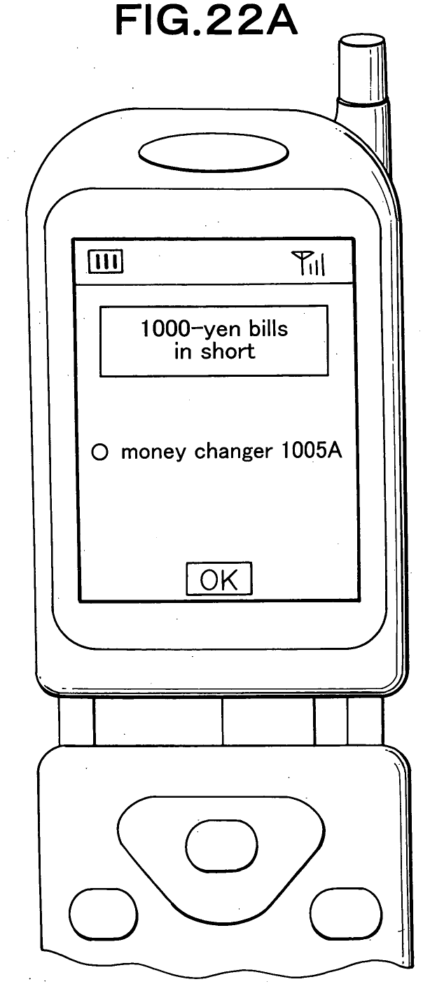

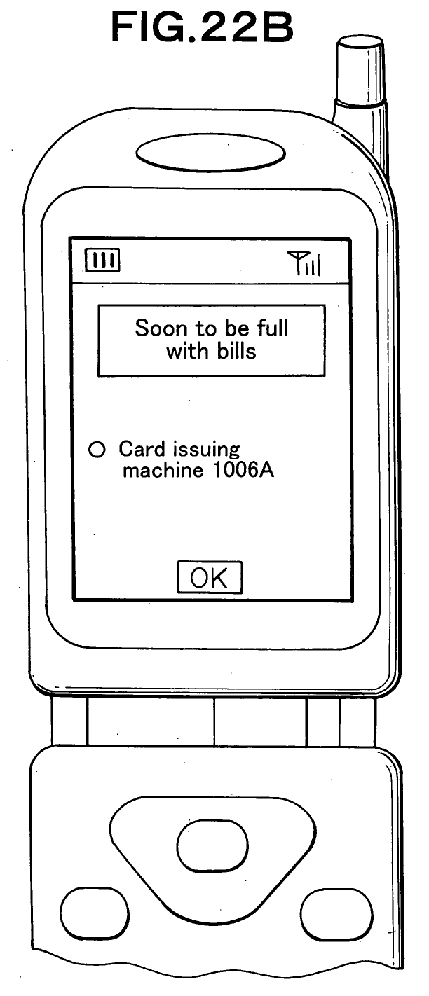

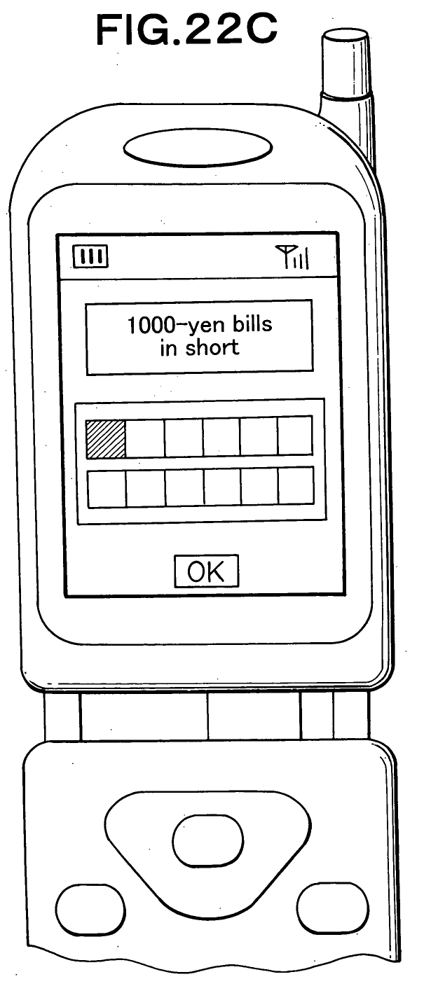

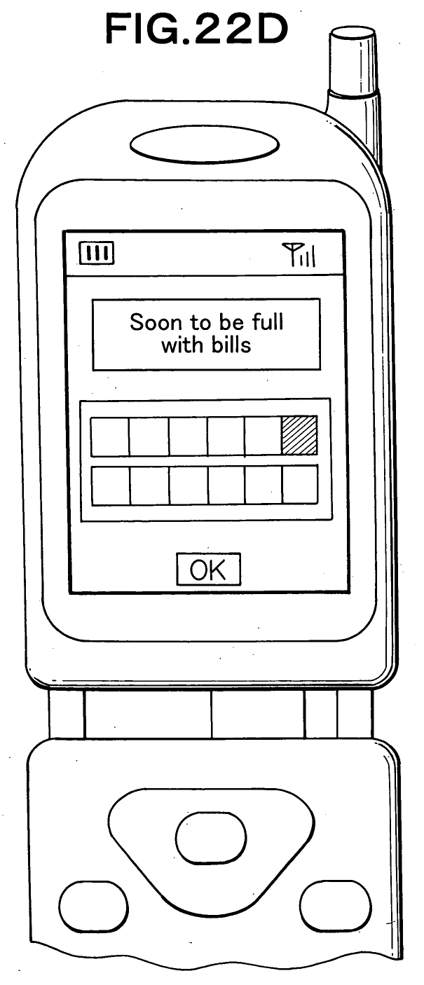

FIGS. 22A to 22D are views schematically showing respective examples of images displayed on the display section of the cellular phone 1007.

FIG. 22A shows an example of image displayed on the display section of the cellular phone 1007 owned by the floor staff member of the arcade 1009 as a result of the emission of a notification signal from the money changer 1005A in the arcade 1009 (see FIG. 10).

An image stating “1000-yen bills in short.” is displayed in the upper part of the display section, whereas an image stating “money changer 1005A” is displayed in the center part thereof. These images act as an alarm image indicating that the amount of 1000-yen bills in the money changer 1005A sending the notification signal has reached a limit (lower limit), i.e., a nearly-end state.

In view of this alarm image, the floor staff member of the arcade 1009 can acquire information concerning the amount of 1000-yen bills in the money changer 1005A in an accurate and timely fashion, and thus can rapidly add 1000-yen bills, thereby preventing the shortage of 1000-yen bills from occurring.

The image shown in FIG. 22B is an example of image displayed on the display section of the cellular phone 1007 owned by the floor staff member of the arcade 1009 as a result of the emission of a notification signal from the card issuing machine 1006A in the arcade 1009 (see FIG. 10).

An image stating “Soon to be full with bills.” is displayed in the upper part of the display section, whereas an image stating “card issuing machine 1006A” is displayed in the center part thereof. These images act as an alarm image indicating that the amount of bills in the card issuing machine 1006A sending the alarm signal has reached a limit (upper limit), i.e., a nearly-full state.

In view of this alarm image, the floor staff member of the arcade 1009 can acquire information concerning the amount of bills in the card issuing machine 1006A in an accurate and timely fashion, and thus can rapidly take out bills, thereby preventing the card issuing machine 1006A from being stuck with bills and from halting its operation.

The image shown in FIG. 22C is another example of image displayed on the display section of the cellular phone 1007 owned by the floor staff member of the arcade 1009 as a result of the emission of a notification signal from the money changer 1005A (see FIG. 10).

In the upper part of the display section, an image stating “1000-yen bills in short.” is displayed. In the center part of the display section, an image showing a rough overhead view of the arcade 1009 is displayed such that the position of the money changer 1005A can be specified.

In view of such an alarm image, the floor staff member of the arcade 1009 can acquire information concerning the amount of 1000-yen bills in the money changer 1005A in an accurate and timely fashion, and can easily specify the position of the money changer 1005A.

The image shown in FIG. 22D is another example of image displayed on the display section of the cellular phone 1007 owned by the floor staff member of the arcade 1009 as a result of the emission of a notification signal from the card issuing machine 1006A in the arcade 1009 (see FIG. 10).

In the upper part of the display section, an image stating “Soon to be full with bills.” is displayed. In the center part of the display section, an image showing a rough overhead view of the arcade 1009 is displayed such that the position of the card issuing machine 1006A can be specified.

In view of such an alarm image, the floor staff member of the arcade 1009 can acquire information concerning the amount of bills in the card issuing machine 1006A in an accurate and timely fashion, and can easily specify the position of the card issuing machine 1006A.

In the foregoing embodiments of the gaming system, the wireless communication terminal unit mounted to the gaming machine may be provided.

The gaming machine in accordance with the second embodiment is applicable not only to the pachinko gaming machine and slot machine, but also to other gaming machines such as poker game machine.

In the gaming system of the present invention, the object to be reported in the arcade-related device is not restricted in particular to the amount of money and the like. When the object to be reported is the amount of money in the arcade-related device, the limit thereof is not limited in particular. Either one or both of the upper and lower limits may be set. When the lower limit is set, money can be added and so forth rapidly in the case of shortage, and the shortage of money can be prevented from occurring if money is added beforehand and so forth. When the upper limit is set, money can be taken out and so forth rapidly in the case where the amount of money in the arcade-related device is in excess, and the amount of money can be prevented from becoming in excess if money is taken out beforehand and so forth. Though the limit for the amount of money is set in terms of the stack in the above-mentioned examples, it may be set in terms of the value of money in the present invention.

The present invention can provide floor staff member of an arcade with information concerning the amount of money in arcade-related devices such as money changer and card issuing machine in an accurate and timely fashion, whereby the shortage of changes and the like can be mended rapidly and can be prevented from occurring.

What is claimed is:

1. A gaming system having a transmitting/receiving device;
the transmitting/receiving device comprising a receiving section, connected via a communication line to a terminal or gaming machine placed in a facility, for wirelessly receiving information from a mobile terminal;
the transmitting/receiving device transmits/receives a predetermined information signal to/from the terminal, the gaming machine, the mobile terminal, or an information managing apparatus placed in the facility in response to an information signal received from the mobile terminal by way of the receiving section; and
the transmitting/receiving device is provided with the terminal, the gaming machine, or the information managing apparatus placed in the facility.

2. A wireless communication terminal unit having a transmitting/receiving device;
the transmitting/receiving device comprising a receiving section, connected via a communication line to a terminal or gaming machine placed in a facility, for wirelessly receiving information from a mobile terminal; and
the transmitting/receiving device transmits/receives a predetermined information signal to/from the terminal, the gaming machine, the mobile terminal, or an information managing apparatus placed in the facility in response to an information signal received from the mobile terminal by way of the receiving section.

3. A wireless communication terminal unit according to claim 2, further comprising a connecting part which connects with a monitor camera module which monitors the facility.

4. A wireless communication terminal unit according to claim 2, comprising a structure attachable to, and detachable from the terminal or gaming machine.

5. A wireless communication terminal unit according to claim 2, wherein the receiving section comprises a receiving surface which receives a personal information signal transmitted from a position in front of the gaming machine.

6. A wireless communication terminal unit according to claim 5, wherein the personal information signal is transmitted via an infrared ray.

7. A wireless communication terminal unit according to claim 2, wherein the wireless communication terminal unit is connected to the terminal or the gaming machine via a wired or wireless communication line.

8. A wireless communication terminal unit according to claim 2, wherein the wireless communication terminal unit is connected to the information managing apparatus via a wired or wireless communication line.

9. A wireless communication terminal unit according to claim 2, wherein the terminal placed in the facility is a terminal which stores therein at least one of information concerning the gaming machine and information concerning a whole arcade where the gaming machine is placed.

10. A wireless communication terminal unit according to claim 2, wherein the terminal placed in the facility is a device which rents a gaming medium utilized in the gaming machine.

11. A wireless communication terminal unit according to claim 2, wherein the terminal placed in the facility is a device which exchanges money.

12. A wireless communication terminal unit according to claim 2, wherein the facility where the terminal is placed is an arcade, an amusement facility where the game machine is placed, a restaurant, or a convenience store.

13. A gaming machine comprising a wireless communication terminal unit having a transmitting/receiving device;
the transmitting/receiving device comprising a receiving section, connected via a communication line to a terminal or gaming machine placed in a facility, for wirelessly receiving information from a mobile terminal; and
the transmitting/receiving device transmits/receives a predetermined signal to/from the terminal, the gaming machine, the mobile terminal, or an information managing apparatus placed in the facility in response to an information signal received from the mobile terminal by way of the receiving section;
wherein the gaming machine further comprises an attachment which is attachable to and detachable from the wireless communication terminal unit.

14. A gaming machine according to claim 13, wherein the gaming machine is a pachinko gaming machine or a slot machine.

15. A gaming system comprising a plurality of gaming machines, at least one of the gaming machines being connected via a communication line to the information managing apparatus and having an attachment which is attachable to and detachable from the wireless communication terminal unit having a transmitting/receiving device;
the transmitting/receiving device comprising a receiving section, connected via a communication line to a terminal or gaming machine placed in a facility, for wirelessly receiving information from a mobile terminal; and
the transmitting/receiving device transmits/receives a predetermined information signal to/from the terminal, the gaming machine, the mobile terminal, or an information managing apparatus placed in the facility in response to an information signal received from the mobile terminal by way of the receiving section.

16. A gaming system comprising the wireless communication terminal unit according to claim. 2, wherein the mobile terminal is a cellular phone, a laptop computer, or a PDA (Personal Digital Assistant).

17. A gaming system comprising:
an arcade-related device, placed in an arcade, which provides a predetermined service in response to insertion of a coin;
an information managing apparatus which is connected to the arcade-related device via a communication line and which comprises a transmitting/receiving device adapted to wirelessly communicate with a mobile terminal operated by a floor staff member of the arcade; and
a notification signal transmitting device which transmits a notification signal to the information managing apparatus when a value of an object to be reported in the arcade-related device reaches a predetermined reference value;
the transmitting/receiving device comprises:
a notification signal receiving device which receives the notification signal; and
an alarm signal transmitting device which transmits an alarm signal to the mobile terminal for displaying onto a display section of the mobile terminal an alarm image indicating that the value of the object to be reported in the arcade-related device sending the notification signal has reached the predetermined reference value when the notification signal is received.

18. A gaming system according to claim 17, wherein the value of the object to be reported is the amount of money stored in the arcade-related device.

19. A gaming system according to claim 17, wherein the alarm image includes an image indicative of a position of the arcade-related device sending the notification signal.

20. A gaming system according to claim 17, wherein the mobile terminal is a cellular phone, a laptop computer, or a PDA (Personal Digital Assistant).

21. A gaming system according to claim 17, wherein the arcade-related device and the information managing apparatus are connected to each other via a wired or wireless communication line.

22. A gaming system according to claim 17, wherein the wireless communication with the mobile terminal is made via an infrared ray.

23. A gaming system according to claim 17, wherein the arcade-related device is a device which rents a gaming medium utilized in the gaming machine.

24. A gaming system according to claim 17, wherein the arcade-related device is a device which exchanges money.

25. A gaming system according to claim 17, wherein the arcade-related device is a prepaid card issuing machine.

26. A gaming system according to claim 17, wherein data for the alarm image is stored in a storage device of the information managing apparatus and transmitted to the mobile terminal together with the alarm signal.

27. A gaming system according to claim 17, wherein data for the alarm signal is stored in a storage device of the mobile terminal and displayed onto the display section of the mobile terminal when the mobile terminal receives the alarm signal.

28. A gaming system according to claim 18, wherein the arcade-related device is a device which rents a gaming medium utilized in the gaming machine; and
wherein the gaming system comprises at least one of a bill nearly-full sensor which outputs a predetermined detection signal when the amount of stored bills reaches a predetermined. upper limit, and a gaming medium nearly-end sensor which outputs a predetermined detection signal when the amount of stored gaming media reaches a predetermined lower limit.

29. A gaming system according to claim 18, wherein the arcade-related device is a device which exchanges money; and
wherein the gaming system comprises at least one of a bill nearly-end sensor which outputs a predetermined detection signal when the amount of stored bills reaches a predetermined lower limit, and a coin nearly-end sensor which outputs a predetermined detection signal when the amount of stored coins reaches a predetermined lower limit.

30. A gaming system according to claim 18, wherein the arcade-related device is a prepaid card issuing machine; and
wherein the gaming system comprises a card nearly-end sensor which outputs a predetermined detection signal when the amount of stored prepaid cards reaches a predetermined lower limit.

31. An information managing apparatus having a transmitting/receiving device;
the transmitting/receiving device comprising:
a notification signal receiving device, connected via a communication line to an arcade-related device placed in an arcade and adapted to provide a predetermined service in response to insertion of a coin, which enables a wireless communication with a mobile terminal operated by a floor staff member of the arcade, and which receives a notification signal transmitted from the arcade-related device when a value of an object to be reported in the arcade-related device reaches a predetermined reference value; and
an alarm signal transmitting device which transmits an alarm signal to the mobile terminal so as to display onto a display section of the mobile terminal an alarm image indicating that the value of the object to be reported in the arcade-related device sending the notification signal when the notification signal is received.

32. An information managing apparatus according to claim 31, wherein the value of the object to be reported is the amount of money stored in the arcade-related device.

33. A wireless communication terminal unit having a transmitting/receiving means;
the transmitting/receiving means comprising a receiving section, connected via a communication line to a terminal or gaming machine placed in a facility, for wirelessly receiving information from a mobile terminal; and
the transmitting/receiving means for transmitting/receiving a predetermined information signal to/from the terminal, the gaming machine, the mobile terminal, or an information managing apparatus placed in the facility in response to an information signal received from the mobile terminal by way of the receiving section.

34. A gaming machine comprising a wireless communication terminal unit having a transmitting/receiving means;
the transmitting/receiving means comprising a receiving section, connected via a communication line to a terminal or gaming machine placed in a facility, for wirelessly receiving information from a mobile terminal; and
the transmitting/receiving means for transmitting/receiving a predetermined information signal to/from the terminal, the gaming machine, the mobile terminal, or an information managing apparatus placed in the facility in response to an information signal received from the mobile terminal by way of the receiving section;
wherein the gaming machine further comprises attachment means for being attachable to and detachable from the wireless communication terminal unit.

35. A gaming system comprising:
an arcade-related device, placed in an arcade, which provides a predetermined service in response to insertion of a coin;
an information managing apparatus which is connected to the arcade-related device via a communication line and which comprises transmitting/receiving means adapted to wirelessly communicate with a mobile terminal operated by a floor staff member of the arcade; and
notification signal transmitting means for transmitting a notification signal to the information managing apparatus when a value of an object to be reported in the arcade-related device reaches a predetermined reference value;
the transmitting/receiving means comprises:
notification signal receiving means for receiving the notification signal; and
alarm signal transmitting means for transmitting an alarm signal to the mobile terminal for displaying onto a display section of the mobile terminal an alarm image indicating that the value of the object to be reported in the arcade-related device sending the notification signal has reached the predetermined reference value when the notification signal is received.

36. An information managing apparatus having transmitting/receiving means;
the transmitting/receiving means comprising:
notification signal receiving means, connected via a communication line to an arcade-related device placed in an arcade and adapted to provide a predetermined service in response to insertion of a coin, for enabling a wireless communication with a mobile terminal operated by a floor staff member of the arcade, and receiving a notification signal transmitted from the arcade-related device when a value of an object to be reported in the arcade-related device reaches a predetermined reference value; and
alarm signal transmitting means for transmitting an alarm signal to the mobile terminal so as to display onto a display section of the mobile terminal an alarm image indicating that the value of the object to be reported in the arcade-related device sending the notification signal when the notification signal is received.
